(19) United States
(12) Patent Application Publication
(10) Pub. No.: US 2005/0184976 A1
(43) Pub. Date: Aug. 25, 2005

(54) Image display apparatus and display driving method for reducing the shock associated with the driving sequence switching

(75) Inventors: Yutaka Chiaki, Kawasaki (JP); Yuichiro Kimura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Kawasaki (JP)

(21) Appl. No.: 10/986,889

(22) Filed: Nov. 15, 2004

(30) Foreign Application Priority Data
Feb. 20, 2004 (JP) 2004-045131

(51) Int. Cl. G09G 3/28

(52) U.S. Cl. 345/204

(57) ABSTRACT

An image display apparatus, which displays an image in multiple grayscales on a display panel by combining a plurality of weighted subfields into which one field has been divided, has an SF usage rate detection circuit, a display SF selection circuit, an SF conversion circuit, and a driving control circuit. The SF conversion circuit selects one of a plurality of prestored light emission pattern tables and outputs an encoded subfield data by encoding an input image signal in accordance with a selected light emission pattern table. The driving control circuit receives an output of the SF conversion circuit, and drives the display panel in accordance with a prescribed driving sequence.

### CROSS REFERENCE TO RELATED APPLICATION

This application is based upon and claims the benefit of priority from the prior Japanese Patent Application No. 2004-045131, filed on Feb. 20, 2004, the entire contents of which are incorporated herein by reference.

### BACKGROUND OF THE INVENTION

1. Field of the Invention

The present invention relates to an image display apparatus and a driving method for the same, and more particularly to an image display apparatus and a driving method for the same, particularly suited to drive a plasma display panel (PDP).

2. Description of the Related Art

With the recent trend toward larger-screen displays, the need for thin display apparatuses has been increasing, and various types of thin display apparatus have been commercially implemented. For example, matrix panels that display images by directly using digital signals are being offered, such as PDPs and other gas discharge display panels, digital micromirror devices (DMDs), EL display devices, fluorescent display tubes, and liquid crystal display devices. Among such thin display apparatuses, gas discharge display panels have been commercially implemented as large-area, direct-view HDTV (high-definition television) display devices, because of their simple process facilitating the fabrication of large-area displays, their self-luminescent properties ensuring good display quality, and their high response speeds.

In a plasma display apparatus, each field (frame) is divided into a plurality of weighted subfields (SFs: light-emission blocks) each comprising a plurality of sustain discharge pulses (sustain pulses), and an image is displayed by controlling the light-emission ON/OFF state of each individual subfield so as to achieve multiple grayscale levels. In such an image apparatus that displays an image in multiple grayscale levels by controlling the ON/OFF states of the respective subfields, it is desired to improve the display capability at low grayscale levels, and it is needed to lengthen the period during which the driving mode remains switched to a driving sequence designed to enhance the display capability at low grayscale levels, while reducing the shock associated with the driving sequence switching. It is also needed to reduce the power consumption by shortening the sustain light-emission period.

In the prior art, there is proposed a display driving method in which, when the maximum luminance is low, and there is a subfield that does not emit light, a subfield whose sustain period is one half of that in the least significant subfield is provided to increase the number of grayscale levels on the black side (refer, for example, to Japanese Unexamined Publication (Kokai) No. 11-065521).

There is also proposed in the prior art an image display apparatus equipped with an adjuster for adjusting the number, Z, of subfields based on image brightness information in order to adjust the brightness of the plasma display panel, and thus capable of adjusting the number of subfields according to the brightness (refer, for example, to Japanese Unexamined Publication (Kokai) No. 11-231825).

The prior art further proposes a PDP display driving pulse control device in which an adjuster is provided that adjusts weight multiplier N (N is a positive integer or a decimal fraction) based on image brightness information so that, even when the weight multiplier changes, the brightness does not change abruptly, and so that the brightness of the plasma display panel can be adjusted without giving the viewer an unnatural feeling (refer, for example, to Japanese Unexamined Publication (Kokai) No. 11-231833).

The prior art and its associated problems will be described in detail later with reference to accompanying drawings.

### SUMMARY OF THE INVENTION

According to the present invention, there is provided an image display apparatus displaying an image in multiple grayscales on a display panel by combining a plurality of weighted subfields into which one field has been divided, comprising an SF usage rate detection circuit detecting the number of pixels used within one field period for each weight of encoded subfield data; a display SF selection circuit outputting a light emission pattern table selection signal, based on an output of the SF usage rate detection circuit; an SF conversion circuit receiving an input image signal as well as the selection signal output from the display SF selection circuit, selecting one of a plurality of prestored light emission pattern tables in accordance with the selection signal, and outputting the encoded subfield data by encoding the input image signal in accordance with the selected light emission pattern table; and a driving control circuit receiving the output of the SF conversion circuit, and driving the display panel in accordance with a prescribed driving sequence.

The SF usage rate detection circuit may include an adder circuit counting up the number of pixels for each of the subfields. The SF usage rate detection circuit may include a usage rate calculating circuit calculating an usage rate of the subfield from an output of the adder circuit.

The SF usage rate detection circuit may take an image input as an input signal. The SF usage rate detection circuit may include an comparator circuit comparing the input image with a predetermined value, and an adder circuit counting up the number of pixels each of which has been determined by the comparator circuit as being equal to or greater than the predetermined value. As many combinations of the comparator circuit and the adder circuit may be provided as the number of light emission tables minus one. The predetermined value used for comparison in the comparator circuit may be a value in the vicinity of a maximum grayscale that is represented by the subfields used for display in the light emission pattern table.

A plurality of the driving sequences may be preset, and wherein the driving control circuit may select one driving sequence that matches the selected light emission pattern table, and may drive the display panel in accordance with the selected driving sequence. The SF usage rate detection circuit may count up the number of pixels over one field period for each weighted subfield data encoded into the subfield data, and may output resulting data on a field-by-field basis. The SF conversion circuit may preselect data to select one of the plurality of light emission pattern tables in accordance with data provided in an arbitrary one of the light emission pattern tables.

Pattern data indicating a light-emission ON/OFF state for each subfield in an arbitrary one of the light emission pattern tables may be data for driving the display panel, and may be also data based on which to switch between the light emission pattern tables. The driving control circuit may drive the display panel by using pattern data in an arbitrary one of the light emission pattern tables; and the SF conversion circuit may select the light emission pattern table by using pattern data that is not used for driving the display panel in the arbitrary one of the light emission pattern tables. Pattern data used by the driving control circuit for driving the display panel may comprise one or more kinds of pattern data including the least heavily weighted pattern data in the light emission table.

The display SF selection circuit may switch the output of the display SF selection circuit when the output of the SF usage rate detection circuit for each weighted subfield is detected as being equal to or lower than a predetermined value. The display SF selection circuit may switch the output of the display SF selection circuit when the output of the SF usage rate detection circuit for one or a plurality of weighted subfields is detected as being zero. The display SF selection circuit may switch an output bit count of the SF usage rate detection circuit in accordance with the output of the display SF selection.

The display SF selection circuit may switch the output on a field-by-field basis, and may determine the present output value based on an output result of a previous field. The output of the display SF selection circuit may have a hysteresis characteristic. The image display apparatus may further comprise an error diffusion control circuit, provided between an image input and the SF conversion circuit, for switching an output bit count of an error diffusion circuit in accordance with the output of the display SF selection circuit.

The driving control circuit may switch from one driving sequence to another progressively in one or a plurality of steps. The one or the plurality of steps where the driving control circuit switches from one driving sequence to another may involve making a sustain period in a relatively heavily weighted and unused subfield equal to or shorter than a sustain period in the least heavily weighted subfield used for display driving, or equal to zero. The one or the plurality of steps where the driving control circuit may switches from one driving sequence to another may involve stopping a relatively heavily weighted subfield having a usage rate of zero. The one or the plurality of steps where the driving control circuit switches from one driving sequence to another may involve inserting a quiescent period before the first subfield or between arbitrarily selected subfields.

The one or the plurality of steps where the driving control circuit switches from one driving sequence to another may involve lengthening a quiescent period gradually in steps, until the quiescent period becomes substantially equal in duration to the period of the least heavily weighted subfield currently driven. The one or the plurality of steps where the driving control circuit switches from one driving sequence to another may involve lengthening a quiescent period gradually in steps, until the quiescent period becomes substantially equal in duration to the period of a subfield whose weight is smaller by one than the least heavily weighted subfield currently driven. The one or the plurality of steps where the driving control circuit switches from one driving sequence to another may involve, in a final step thereof, inserting in a quiescent period a subfield whose weight is smaller by one than the least heavily weighted subfield currently displayed.

The one or the plurality of steps where the driving control circuit switches from one driving sequence to another may involve, in a final step thereof, inserting in a quiescent period a subfield whose weight is smaller by one than the least heavily weighted subfield currently displayed, and stopping a subfield to which the most heavily weighted subfield data is assigned. The one or the plurality of steps where the driving control circuit switches from one driving sequence to another may involve, in a final step thereof, inserting in a quiescent period a subfield whose weight is smaller by one than the least heavily weighted subfield currently displayed, and rearranging the time order in which to drive the plurality of subfields. The one or the plurality of steps where the driving control circuit switches from one driving sequence to another may involve, in a final step thereof, inserting in a quiescent period a subfield whose weight is smaller by one than the least heavily weighted subfield currently displayed, and rearranging the time order in which to drive the plurality of subfields, in order of increasing weight.

According to the present invention, there is also provided an image display apparatus displaying an image in multiple grayscales in accordance with a signal level of an input signal, wherein the image is displayed by switching, according to video content thereof, between a first grayscale characteristic where an output level monotonically increases with increasing grayscale and a second grayscale characteristic including a region where the output level remains constant despite the increase in grayscale.

Further, according to the present invention, there is provided a driving method for an image display apparatus displaying an image in multiple grayscales on a display panel by combining a plurality of weighted subfields into which one field has been divided, comprising: detecting the number of pixels used within one field period for each encoded subfield; outputting a light emission pattern table selection signal in accordance with the number of pixels detected for each subfield; receiving an input image signal, selecting one of a plurality of prestored light emission pattern tables in accordance with the selection signal, and outputting the encoded subfield data by encoding the input image signal in accordance with the selected light emission pattern table; and displaying an image in accordance with the encoded subfield data by using a prescribed driving sequence.

The outputting of the light emission pattern table selection signal may detect an usage rate of each subfield based on the number of pixels detected for the each subfield, and may output the light emission pattern table selection signal in accordance with the detected subfield usage rate. The detecting of the number of pixels may take an image input as an input signal. The detecting of the number of pixels may compare the input image with a predetermined value, and may count up the number of pixels each of which has been determined as a result of the comparison as being equal to or greater than the predetermined value. The predetermined value may be a value in the vicinity of a maximum grayscale that is represented by the subfields used for display in the light emission pattern table.

A plurality of the driving sequences may be preset, and wherein the displaying of the image may select one driving sequence that matches the selected light emission pattern table, and may display an image in accordance with the selected driving sequence. The detecting of the number of pixels may count up the number of pixels over one field period for each weighted subfield data encoded into the subfield data, and may output resulting data on a field-by-field basis. The outputting encoded subfield data may prestore data selecting one of the plurality of light emission pattern tables in accordance with data provided in an arbitrary one of the light emission pattern tables.

In the outputting encoded subfield data, pattern data indicating a light-emission ON/OFF state for each subfield in an arbitrary one of the light emission pattern tables may be data for driving the display panel, and may be also data based on which to switch between the light emission pattern tables. The displaying of the image may drive the display panel by using pattern data in an arbitrary one of the light emission pattern tables; and the outputting encoded subfield data may prestore data selecting the light emission pattern table by using pattern data that is not used for driving the display panel in the arbitrary one of the light emission pattern tables. The displaying of the image may drive the display panel by using one or more kinds of pattern data including the least heavily weighted pattern data in the light emission table.

Pattern data used for driving the display panel, from the highest grayscale X, or a grayscale close thereto, that is represented by the subfields used for display driving in the light emission pattern table to the highest grayscale Z that is represented by all the subfields in the light emission pattern table, may be data where all pattern data or most of relatively heavily weighted pattern data indicate a light-emission ON state. The plurality of light emission pattern tables may comprise first and second light emission pattern tables where each corresponding one of the subfields is assigned the same weight; and the first light emission pattern table may provide an output which is linear with respect to an input and may have a one-to-one correspondence therewith, while the second light emission pattern table may be the light emission pattern table corresponding to one driving sequence selected by the driving control circuit in a plurality of the driving sequences.

The grayscale from the grayscale X to the grayscale Z of the data that is the second light emission pattern table to switch between the emission pattern tables and that indicates the light-emission ON state of one or a plurality of pieces of weighted pattern data, may be the same as the grayscale from the grayscale X to the grayscale Z of the data that is the first light emission pattern table, and that indicates the light-emission ON state of one or a plurality of pieces of pattern data of the same weight of the second light emission pattern table to switch between the light emission pattern tables. The data that is used to switch between the light emission pattern tables, and that indicates the light-emission ON state of one or a plurality of pieces of weighted pattern data, may be located at a grayscale lower than the grayscale X in the second light emission pattern table. The number of pieces of data each of which is used in the second light emission pattern table to switch between the light emission pattern tables from the grayscale X to the grayscale Z, and which indicates the light emission ON state for each of one or a plurality of pieces of weighted pattern data, is smaller than the number of pieces of data which indicate the light emission ON state from the grayscale X to the grayscale Z in the first light emission pattern table.

The plurality of driving sequences may include subfields of the same weight and subfields of different weights, and time positions at which the subfields of the same weight may be caused to emit light are substantially the same between the plurality of driving sequences. The plurality of driving sequences may include subfields of the same weight and subfields of different weights, and the order where each of the subfields of the same weight is caused to emit light may be the same between the plurality of driving sequences.

The outputting of the light emission pattern table selection signal may switch the selection signal when the output for each weighted subfield in the detecting of the number of pixels is detected as being equal to or lower than a predetermined value. The outputting of the light emission pattern table selection signal may switch the selection signal when the output for one or a plurality of weighted subfields in the detecting of the number of pixels is detected as being zero. The outputting of the light emission pattern table selection signal may switch an output bit count for the detected number of pixels in accordance with the selection signal.

The outputting of the light emission pattern table selection signal may switch the output on a field-by-field basis, and may determine the present output value based on an output result of a previous field. The outputting of the light emission pattern table selection signal may output the selection signal by providing a hysteresis characteristic thereto. The driving method for an image display apparatus may further comprise changing the number of bits used for error diffusion in accordance with the selection signal.

Switching from one driving sequence to another may be done progressively in one or a plurality of steps. The one or the plurality of steps where switching is made from one driving sequence to another may involve making a sustain period in a relatively heavily weighted and unused subfield equal to or shorter than a sustain period in the least heavily weighted subfield used for display driving, or equal to zero. The one or the plurality of steps where switching is made from one driving sequence to another may involve stopping a relatively heavily weighted subfield having a usage rate of zero. The one or the plurality of steps where switching is made from one driving sequence to another may involve inserting a quiescent period before the first subfield or between arbitrarily selected subfields.

The one or the plurality of steps where switching is made from one driving sequence to another may involve lengthening a quiescent period gradually in steps, until the quiescent period becomes substantially equal in duration to the period of the least heavily weighted subfield currently driven. The one or the plurality of steps where switching is made from one driving sequence to another may involve lengthening a quiescent period gradually in steps, until the quiescent period becomes substantially equal in duration to the period of a subfield whose weight is smaller by one than the least heavily weighted subfield currently driven. The one or the plurality of steps where switching is made from one driving sequence to another may involve, in a final step thereof, inserting in a quiescent period a subfield whose weight is smaller by one than the least heavily weighted subfield currently displayed.

The one or the plurality of steps where switching is made from one driving sequence to another may involve, in a final step thereof, inserting in a quiescent period a subfield whose weight is smaller by one than the least heavily weighted subfield currently displayed, and stopping a subfield to which the most heavily weighted subfield data is assigned. The one or the plurality of steps where switching is made from one driving sequence to another may involve, in a final step thereof, inserting in a quiescent period a subfield whose weight is smaller by one than the least heavily weighted subfield currently displayed, and rearranging the time order in which to drive the plurality of subfields. The one or the plurality of steps where switching is made from one driving sequence to another may involve, in a final step thereof, inserting in a quiescent period a subfield whose weight is smaller by one than the least heavily weighted subfield currently displayed, and rearranging the time order in which to drive the plurality of subfields, in order of increasing weight.

The display panel may be driven by selecting one driving sequence from among the plurality of driving sequences for the selected one light emission pattern table. In the plurality of light emission pattern tables, the weight of a relatively lightly weighted subfield may be a value expressed as a power of 2, while the weight of a relatively heavily weighted subfield is not a value expressed as a power of 2.

In addition, according to the present invention, there is also provided a driving method for an image display apparatus displaying an image in multiple grayscales in accordance with a signal level of an input signal, wherein the image is displayed by switching, according to video content thereof, between a first grayscale characteristic where an output level monotonically increases with increasing grayscale and a second grayscale characteristic which includes a region where the output level remains constant despite the increase in grayscale.

The second grayscale characteristic may have a finer grayscale step in a low grayscale region than the first grayscale characteristic. The image display apparatus may be a plasma display apparatus.

### BRIEF DESCRIPTION OF THE DRAWINGS

The present invention will be more clearly understood from the description of the preferred embodiments as set forth below with reference to the accompanying drawings, wherein:

FIG. 1 is a diagram showing one example of a driving sequence in an image display apparatus according to the prior art;

FIG. 2 is a block diagram showing one embodiment of an image display apparatus according to the present invention;

FIG. 3 is a block diagram showing one example of a grayscaling circuit in the image display apparatus of the present invention;

FIG. 4 is a diagram showing a first example of a light emission pattern in an SF conversion circuit in the image display apparatus of the present invention;

FIG. 5 is a diagram showing a second example of the light emission pattern in the SF conversion circuit in the image display apparatus of the present invention;

FIG. 6 is a diagram showing a third example of the light emission pattern in the SF conversion circuit in the image display apparatus of the present invention;

FIG. 7 is a block diagram showing one example of an error diffusion control circuit in FIG. 3;

FIG. 8 is a block diagram showing one example of an SF usage rate detection circuit in the image display apparatus of the present invention;

FIG. 9 is a block diagram showing one example of a display SF selection circuit in the image display apparatus of the present invention;

FIG. 10 is a table showing an output example of the display SF selection circuit in the image display apparatus of the present invention;

FIG. 11 is a diagram showing a first embodiment of the driving sequences used in the image display apparatus according to the present invention;

FIG. 12 is a block diagram showing one example of a driving control circuit in the image display apparatus of the present invention;

FIG. 13 is a flowchart showing one example of image display processing in the image display apparatus of the present invention;

FIG. 14 is a flowchart showing another example of image display processing in the image display apparatus of the present invention;

FIG. 15 is a diagram showing a fourth example of the light emission pattern in the SF conversion circuit in the image display apparatus of the present invention;

FIG. 16 is a diagram showing a fifth example of the light emission pattern in the SF conversion circuit in the image display apparatus of the present invention;

FIG. 17 is a diagram showing a sixth example of the light emission pattern in the SF conversion circuit in the image display apparatus of the present invention;

FIG. 18 is a diagram showing a seventh example of the light emission pattern in the SF conversion circuit in the image display apparatus of the present invention;

FIG. 19 is a diagram showing an eighth example of the light emission pattern in the SF conversion circuit in the image display apparatus of the present invention;

FIG. 20 is a flowchart showing one example of display SF selection processing in the image display apparatus of the present invention;

FIG. 21 is a diagram showing a first example of the hysteresis characteristic that the output of the display SF selection circuit exhibits in the image display apparatus of the present invention;

FIG. 22 is a flowchart showing another example of the display SF selection processing in the image display apparatus of the present invention;

FIG. 23 is a diagram showing a second example of the hysteresis characteristic that the output of the display SF selection circuit exhibits in the image display apparatus of the present invention;

FIG. 24 is a diagram showing a third example of the hysteresis characteristic that the output of the display SF selection circuit exhibits in the image display apparatus of the present invention;

FIG. 25 is a diagram showing a second embodiment of the driving sequences used in the driving control circuit in the image display apparatus of the present invention;

FIG. 26 is a diagram showing a third embodiment of the driving sequences used in the driving control circuit in the image display apparatus of the present invention;

FIG. 27 is a diagram showing a fourth embodiment of the driving sequences used in the driving control circuit in the image display apparatus of the present invention;

FIG. 28 is a diagram showing a fifth embodiment of the driving sequences used in the driving control circuit in the image display apparatus of the present invention;

FIG. 29 is a block diagram showing another embodiment of an image display apparatus according to the present invention; and

FIG. 30 is a block diagram showing another example of the SF usage rate detection circuit in the image display apparatus of the present invention.

### DESCRIPTION OF THE PREFERRED EMBODIMENTS

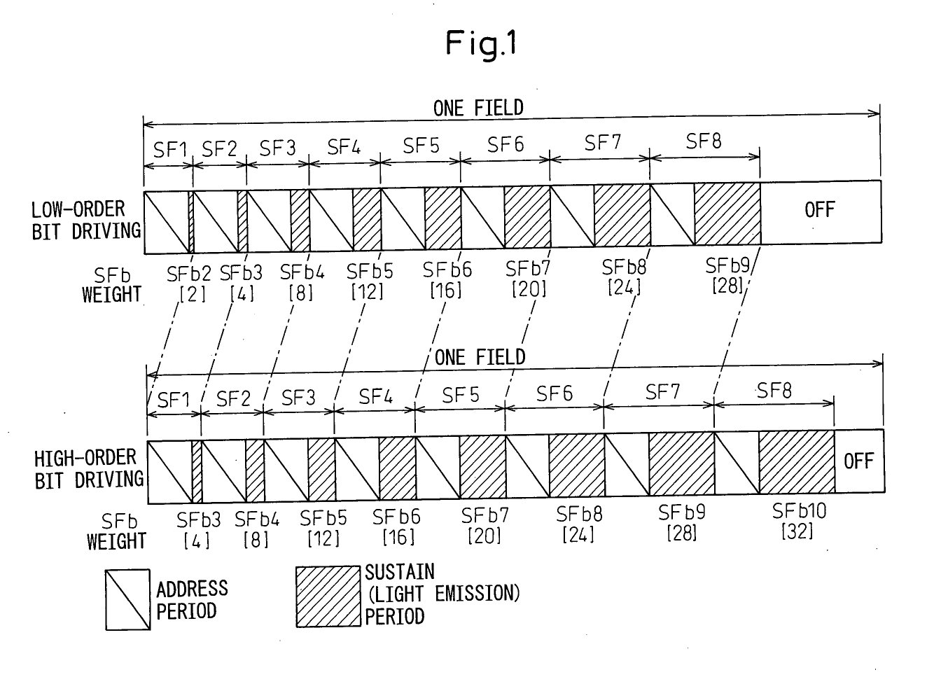

Before proceeding to the detailed description of the preferred embodiments of the present invention, the prior art image display apparatuses and display driving methods and their associated problems will be described with reference to FIG. 1.

In the prior art, there is proposed, for example, in Japanese Unexamined Publication (Kokai) No. 11-065521, a display driving method in which, when the maximum luminance is low, and there is a subfield that does not emit light, a subfield whose sustain period is one half of that in the least significant subfield is provided to increase the number of grayscale levels on the black side.

FIG. 1 is a diagram showing one example of a driving sequence in the prior art image display apparatus.

As shown in FIG. 1, in the prior art method, when driving one field by using eight subfields SF1 to SF8 each assigned a different weight, eight subfields SFb3 to SFb10 having weights of 4, 8, 12, 16, 20, 24, 28, and 32, respectively are used, for example, for high-order bit driving, while on the other hand, when the maximum luminance is low, low-order bit driving is performed using subfields SFb2 to SFb9 by excluding the most heavily weighted subfield SFb10 (weight 32) but instead adding the subfield SFb2 whose weight (2) is one half of that of the subfield SFb3 of weight 4, thus aiming at improving the display capability at low grayscale levels.

As described with reference to FIG. 1, according to the method proposed in the prior art, when the maximum luminance is low, the most heavily weighted subfield (SFb10) is not used, but instead, the subfield (SFb2) whose weight (2) is smaller than the weight (4) of the least heavily weighted subfield (SFb3) is added, thereby improving the display capability at low grayscale levels.

However, in actual video data such as television broadcasts, the most significant bit (the most heavily weighted subfield SFb10) is used in almost all cases, and the least significant bit driving is seldom selected; therefore, even though the display capability at low grayscale levels can be enhanced by selecting the least significant bit driving, the period during which the driving mode remains switched to the least significant bit driving is extremely short, and no practical effect can be obtained.

Further, between the low-order bit driving sequence and the high-order bit driving sequence in FIG. 1, the subfield having the same weight is shifted in time within one field. More specifically, in the low-order bit driving sequence, the subfield SFb2 whose weight is 2 is driven first, while on the other hand, in the high-order bit driving sequence, the subfield SFb3 whose weight is 4 is driven first, which means that, in the high-order bit driving sequence, the sequence is shifted in time backward by an amount equal to the driving time of the subfield SFb2. As a result, the center of gravity of light emission markedly changes between the low-order bit driving sequence and the high-order bit driving sequence; therefore, when the display driving bits are changed, that is, when switching is made from the low-order bit driving sequence to the high-order bit driving sequence or vice versa, shock associated with the switching occurs, giving the person (the viewer) viewing the image display apparatus an unnatural feeling. In particular, if such switching is repeated a plurality of times in a short time, a phenomenon such as flicker occurs, resulting in a degradation of image quality.

An object of the invention is to provide an image display apparatus and a driving method for the same that can lengthen the period during which the driving mode remains switched to a driving sequence designed to enhance the display capability at low grayscale levels, and can reduce the shock associated with the driving sequence switching. Another object of the invention is to provide an image display apparatus and a driving method for the same that can reduce the power consumption by shortening the sustain light-emission period.

Below, embodiments of an image display apparatus and a driving method for the image display apparatus according to the present invention will be described in detail with reference to the accompanying drawings.

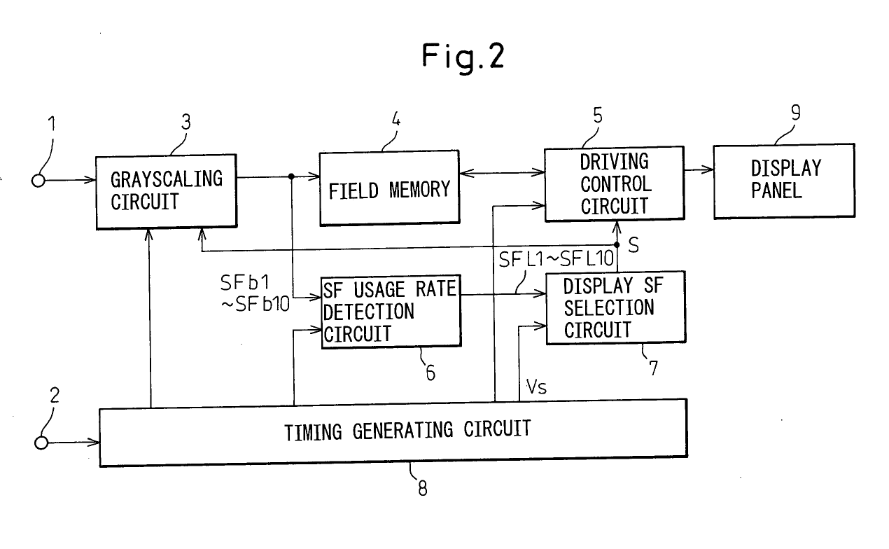

FIG. 2 is a block diagram showing one embodiment of an image display apparatus according to the present invention. In FIG. 2, reference numeral 1 is a digital video signal input terminal, 2 is a synchronization signal input terminal for a horizontal synchronization signal, a vertical synchronization signal, a display period signal indicating a display period, a clock signal, etc., 3 is a grayscaling circuit, 4 is a field memory, 5 is a driving control circuit, 6 is an SF usage rate detection circuit, 7 is a display SF selection circuit, 8 is a timing generating circuit, and 9 is a display panel.

The field memory 4 stores data for one field and, in the next field period, sequentially outputs the stored data for the one field for each SF. The timing generating circuit 8 is a circuit that generates various timing signals such as synchronization signals. The display panel is, for example, a plasma display panel or the like, and contains various drivers (for example, an X driver, Y driver, and address driver as used in a three-electrode AC-driven type PDP).

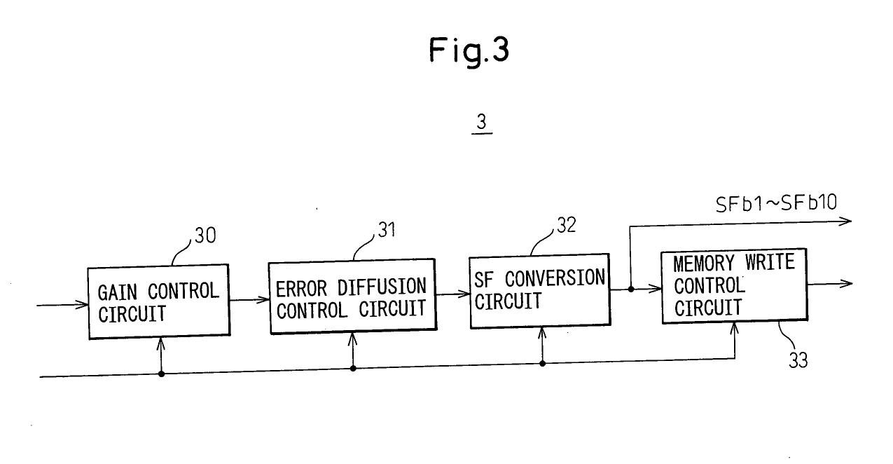

FIG. 3 is a block diagram showing one example of the grayscaling circuit 3 in the image display apparatus of the present invention. In FIG. 3, reference numeral 30 is a gain circuit, 31 is an error diffusion control circuit, 32 is an SF conversion circuit, and 33 is a memory write control circuit which controls writing to the field memory 4 that follows the grayscaling circuit 3.

The gain circuit 30 is a circuit by which the video signal supplied via the video signal input terminal 1 is normalized to the number of grayscale levels used in the light emission pattern employed in the SF conversion circuit 32; for example, when the input video signal is an 8-bit, 256-step signal, and the number of grayscale levels to be converted by the SF conversion circuit 32 is 147, then the gain value of the gain circuit 30 is set to 147/256.

The memory write control signal 33 includes a one-line memory which temporarily stores video data that has been converted into subfield data for one line, and writes the subfield data for the one line to the field memory 4 on a subfield SFb by subfield SFb basis, that is, after parallel-to-serial conversion; at this time, a memory write control signal is also generated.

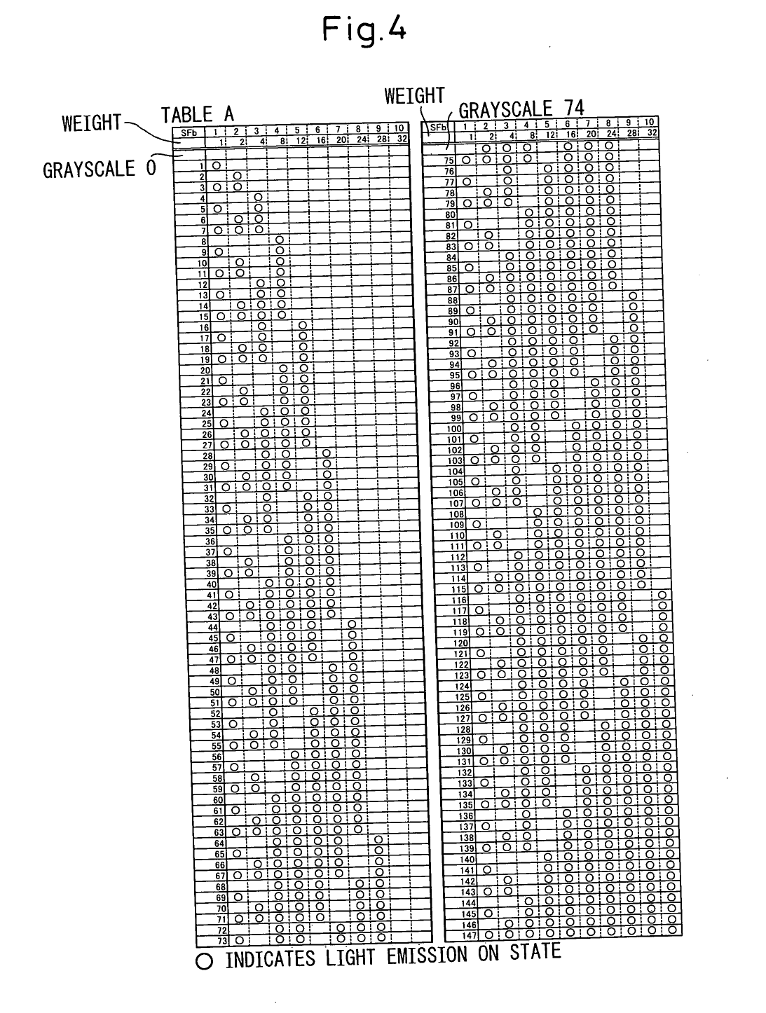

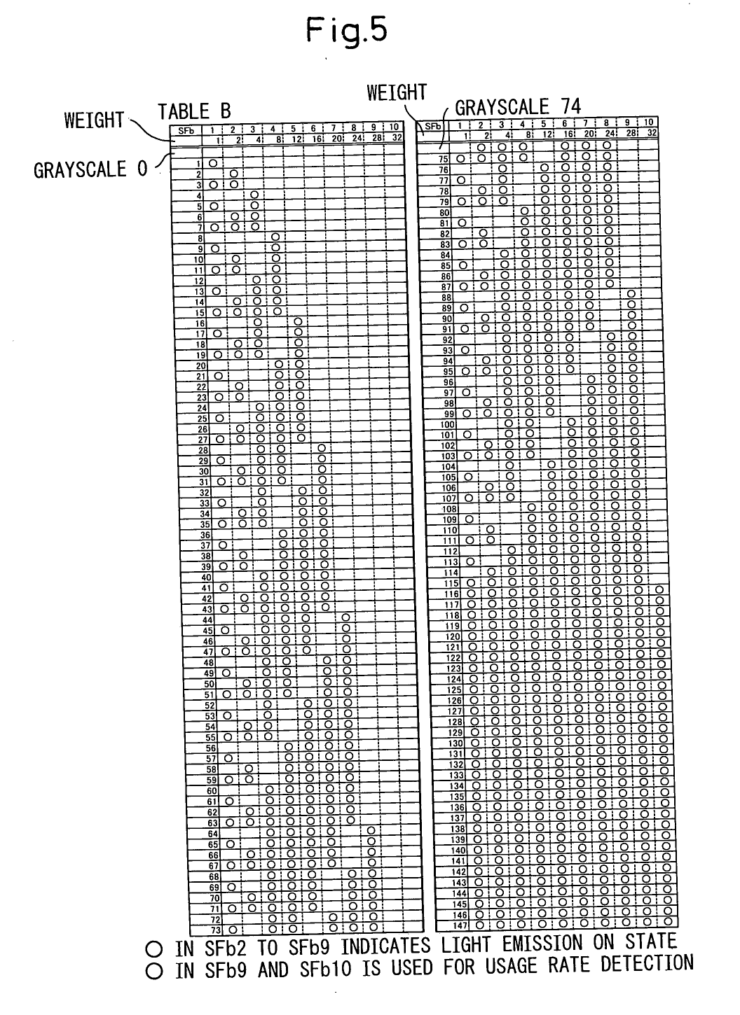

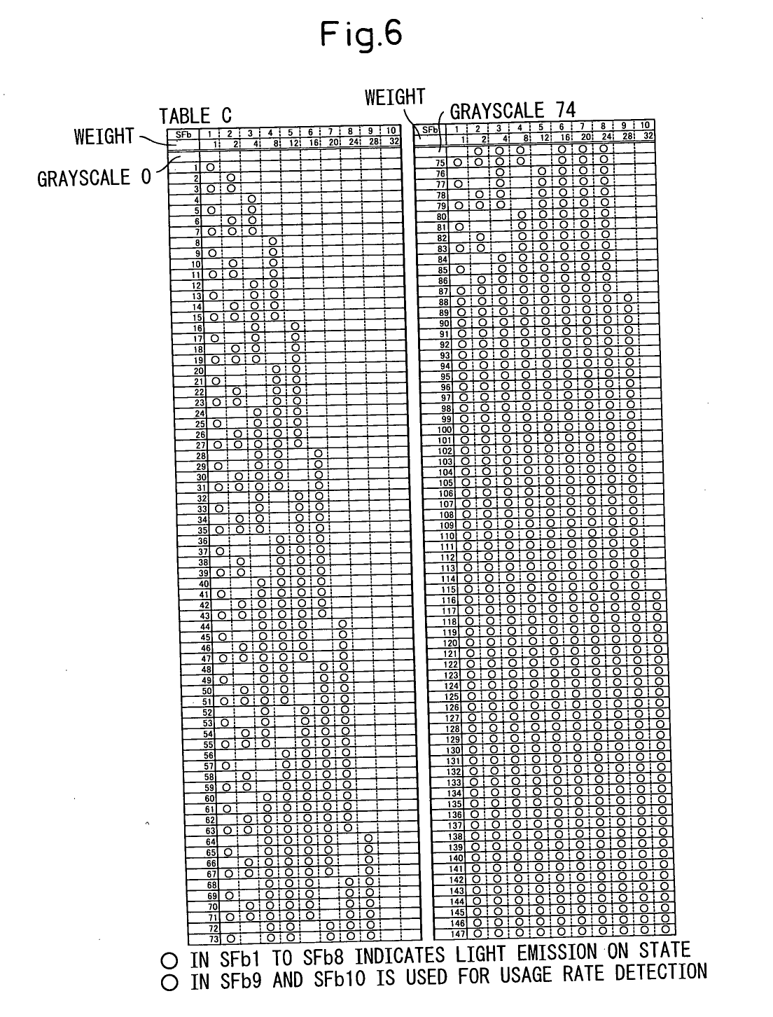

FIGS. 4 to 6 are diagrams each showing an example of the light emission pattern (light emission pattern table) in the SF conversion circuit in the image display apparatus of the present invention: FIG. 4 shows the first example of the light emission pattern (SF light emission pattern table A), FIG. 5 shows the second example of the light emission pattern (SF light emission pattern table B), and FIG. 6 shows the third example of the light emission pattern (SF light emission pattern table C). In each Fig., o indicates the light emission ON state.

As shown in FIGS. 4 and 5, the light emission pattern data for the subfields SFb is the same between the SF light emission pattern tables A and B up to the grayscale level 115; however, for the grayscale levels of 116 and higher, while the light emission patterns in the SF light emission pattern table A of FIG. 4 still match the grayscale levels they represent, the pattern data in the SF light emission pattern table B of FIG. 5 shows that all the subfields SFb (SFb1 to SFb10) are ON for the grayscale levels of 116 and higher.

In the light emission pattern table C of FIG. 6, the pattern data is the same as that in light emission pattern table B of FIG. 5 in that all the subfields SFb1 to SFb10 are ON for the grayscale levels of 116 and higher, but differs in that, for the grayscale levels from 88 to 115, the subfields SFb1 to SFb9, excluding SFb10 of the heaviest weight (32), are all ON.

Here, in the light emission pattern table A, the subfields SFb used for driving are eight subfields SFb3 to SFb10, while in the light emission pattern table B, the subfields SFb used for driving are eight subfields SFb2 to SFb9 and, as a result, the grayscale levels 116 and higher are fixed to 116. Further, in the light emission pattern table C, the subfields SFb used for driving are eight subfields SFb1 to SFb8 and, as a result, the grayscale levels 88 and higher are fixed to 88.

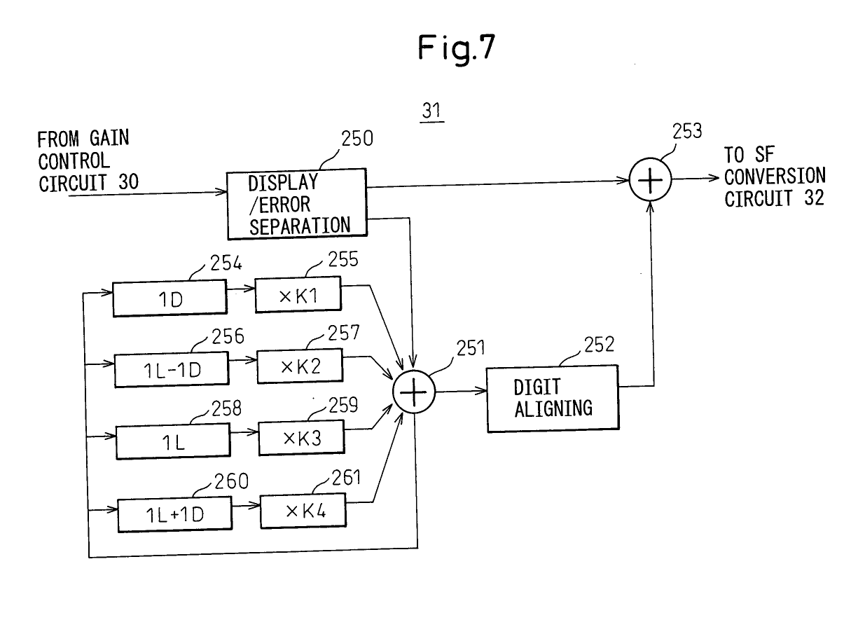

FIG. 7 is a block diagram showing one example of the error diffusion control circuit 31 in FIG. 3. In FIG. 7, reference numeral 250 is a display/error separation circuit which separates display bits and diffusion bits, 254 is a one-pixel (1D) delay circuit, 256 is a one-line minus one-pixel (1L−1D) delay circuit, 258 is a one-line (1L) delay circuit, and 260 is a one-line plus one-pixel (1L+1D) delay circuit. Further, reference numeral 255 is a multiply-by-K1 multiplier circuit, 257 is a multiply-by-K2 multiplier circuit, 259 is a multiply-by-K3 multiplier circuit, 261 is a multiply-by-K4 multiplier circuit, 251 and 253 are adder circuits, and 252 is a digit aligning circuit which aligns bits for adding the carry data from the adder circuit 251 to the display bits output from the display/error separation circuit 250. Then, in accordance with the grayscale to be displayed, the bits separated by the display/error separation circuit 250 and the bits output from the digit aligning circuit 252 are added together by the adder circuit 253.

In the error diffusion control circuit 31, when driving eight subfields SFb3 to SFb10 (with reference to SF light emission pattern table A shown in FIG. 4) for display, since the number of grayscale levels, including the grayscale level 0, that can be represented by the subfields SFb3 to SFb10 is 148/4=37 which can be expressed by 6 bits. The 6 high-order bits (6 high-order bits including the most significant bit (MSB): display bits) are added up in order to spatially express the data represented by the 6 high-order bits, and these 6 high-order bits, plus a carry which is caused by diffusion bits, if any, are used for display driving. When driving subfields SFb2 to SFb9 for display, the 7 high-order bits including the MSB should be spatially expressed.

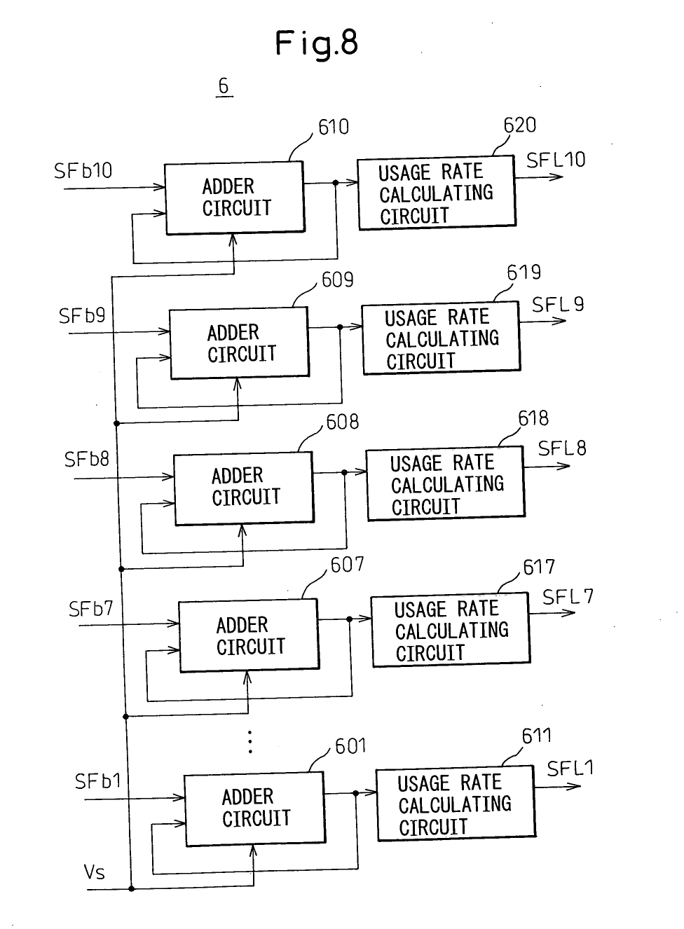

FIG. 8 is a block diagram showing one example of the SF usage rate detection circuit 6 in the image display apparatus of the present invention. In FIG. 8, reference numerals 601 to 610 are adder circuits, and 611 to 620 are usage rate calculating circuits.

The adder circuits 601 to 610 add up the number of pixels for one field for the respective subfields SFb1 to SFb10 into which the input data has been converted by the grayscaling circuit 3, and the usage rate calculating circuits 611 to 620 calculate the ratios (usage rates) SFL1 to SFL10 of the respective subfields SFb1 to SFb10 to the total number of pixels of the screen for each field, and output the results.

Here, the adder circuits 601 to 610 each require the number of bits corresponding to the total number of pixels of the screen; for output bits of each of the usage rates SFL1 to SFL10, when the number of pixels is 480 vertically and 640 horizontally, for example, the total number of pixels is 307200 dots and an adder with 20 bits becomes necessary, but in the present invention, 20 bits are not needed for output, but less than 20 bits suffice for the purpose. This is because, in the case of the 8 high-order bits, for example, since the SFL output is a 1 for 1200 dots, the 1200 dots (1/256 in terms of ratio) can be disregarded. In the adder circuit, as the number of output bits increases, the number of pixels disregarded decreases, and the accuracy of the decision increases correspondingly, but the decision becomes more sensitive to video signal noise; therefore, by reducing the number of bits to less than 20 bits, an erroneous detection attributable to noise can be avoided. In the present invention, the usage rate with respect to the full screen is calculated and output, but alternatively, the result of the addition may be output directly.

The SF usage rate detection circuit 6 can be constructed using the adder circuits 601 to 610 only and not using the usage rate calculating circuits 611 to 620.

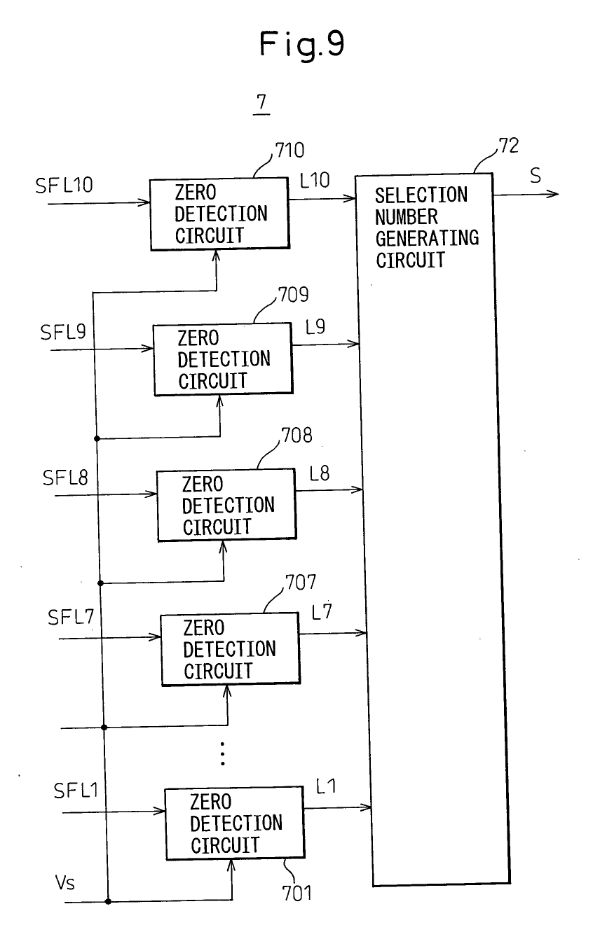

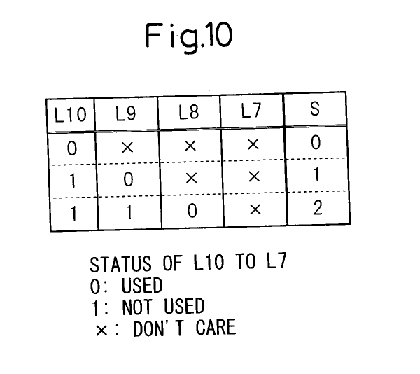

FIG. 9 is a block diagram showing one example of the display SF selection circuit 7 in the image display apparatus of the present invention, and FIG. 10 is a table showing an output example of the display SF selection circuit 7 in the image display apparatus of the present invention. In FIG. 9, reference numerals 701 to 710 are zero detection circuits, and 72 is a selection number generating circuit.

The zero detection circuits 701 to 710 detect on a field-by-field basis whether the values of the respective outputs SFL1 to SFL10 of the SF usage rate detection circuit 6 are zero “0” or not, and output signals L1 to L10 to the selection number generating circuit 72. Each of the zero detection circuits 701 to 710 outputs “0” when the value of the corresponding one of the usage rates SFL1 to SFL10 is “0”, that is, when the corresponding one of the subfields SFb1 to SFb10 is used, and “1” when the value of the corresponding one of the usage rates SFL1 to SFL10 is not “0”. The selection number generating circuit 72 outputs a signal S, such as shown in FIG. 10, in relation to the usage rates SFL7 to SFL10.

More specifically, when the signal L10 from the zero detection circuit 710 is “0”, that is, when the subfield SFb10 is used, S=0 is output regardless of the values of the signals L9 to L7 (L9 to L1) from the zero detection circuits 709 to 707. On the other hand, when the signal L10 from the zero detection circuit 710 is “1”, and the signal L9 from the zero detection circuit 709 is “0”, that is, when the subfield SFb10 is not used, but the subfield SFb9 is used, S=1 is output regardless of the values of the signals L8 and L7 (L8 to L1) from the zero detection circuits 708 and 707.

Further, when the signals L10 and L9 from the zero detection circuits 710 and 709 are both “1”, and the signal L8 from the zero detection circuit 708 is “0”, that is, when neither the subfield SFb10 nor the subfield SFb9 is used, but the subfield SFb8 is used, S=2 is output regardless of the value of the signal and L7 (L7 to L1) from the zero detection circuit 707. The output S of the selection number generating circuit 72, as the output of the display SF selection circuit 7, is supplied to the driving control circuit 5 as well as to the grayscaling circuit 3.

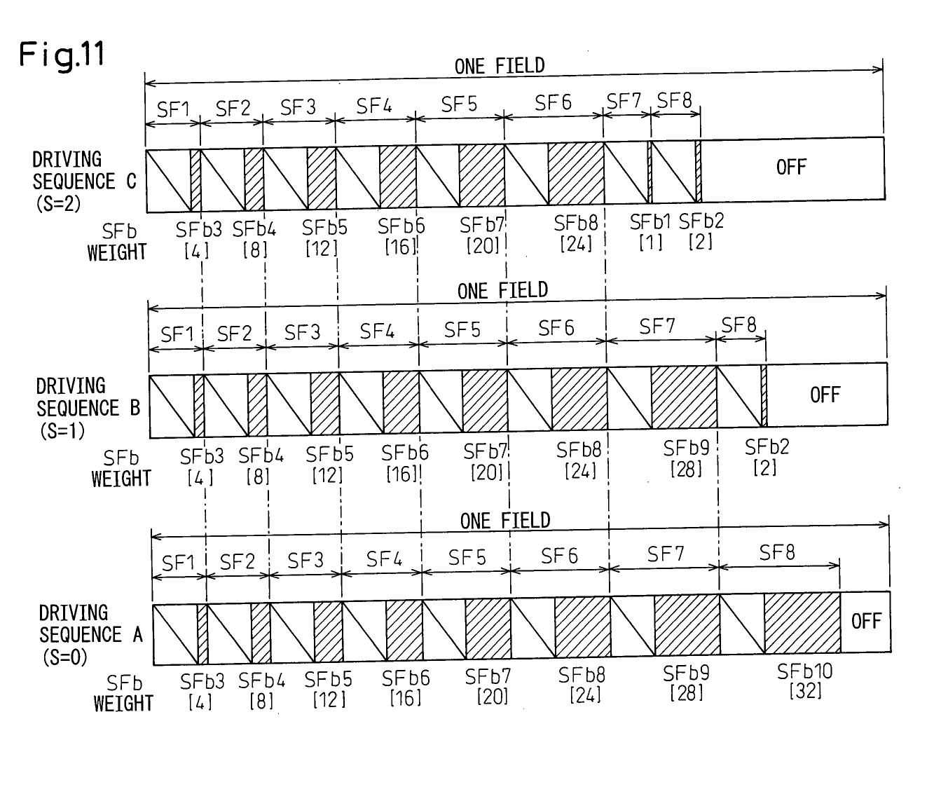

FIG. 11 is a diagram showing a first embodiment of the driving sequences used in the image display apparatus according to the present invention; in the example shown here, one field is driven using eight subfields SF1 to SF8.

The driving control circuit 5 switches the driving sequence in accordance with the output S of the display SF selection circuit 7. That is, as shown in FIG. 11, the driving control circuit 5 drives the display panel 9 by the driving sequence A when S=0, by the driving sequence B when S=1, and by the driving sequence C when S=2. As is apparent from FIG. 11, even when the output S of the display SF selection circuit 7 changes from S=0 to S=1 to S=2, the subfields SFb3 to SFb8 located at the time positions of SF1 to SF6 within one field remain at the same positions, that is, the time positions of the subfields SFb3 to SFb8 having the same weights between the driving sequences A to C do not change; accordingly, hardly any shock occurs when switching is made, for example, between the driving sequence A for S=O and the driving sequence B for S=1.

Further, at the instant that switching is made, for example, from the driving sequence A to the driving sequence B, since the number of pixels in the subfield SFb10 of weight 32 is close to zero (when the usage rate SFL is 8 bits, and 1/256 is set as zero, if the usage rate shows zero, the usage rate may not actually be zero), the subfield SFb10 is emitting virtually no light, so that the position of the center of gravity remains substantially unchanged. Furthermore, even when the driving sequence is switched, for example, between the driving sequence B for S=1 and the driving sequence C for S=2, the time positions where the relatively heavily weighted subfields SFb3 to SFb8 emit light remain unchanged at SF1 to SF6 within the one field; as a result, the amount of shift in the position of the center of gravity can be reduced, and thus the switching shock associated with the driving sequence switching can be alleviated. Here, the usage rate of zero is preferable, but if not zero, a usage rate close to zero suffices for the purpose.

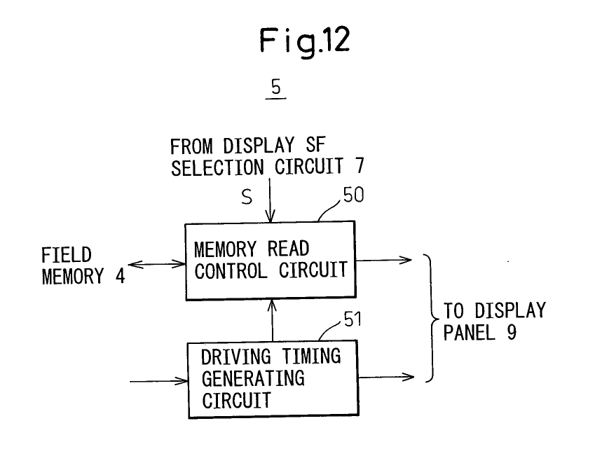

FIG. 12 is a block diagram showing one example of the driving control circuit 5 in the image display apparatus of the present invention. In FIG. 12, reference numeral 50 is a memory read control circuit, and 51 is a driving timing generating circuit which generates various timing signals necessary for the display apparatus and outputs them to the display apparatus.

The memory read control circuit 50, in accordance with the timing generated by the driving timing generating circuit 51, reads out the data for one field on a subfield SFb by subfield SFb basis from the field memory 4 in which the data for each line has been written on a subfield SFb by subfield SFb basis, and outputs the thus readout data for each subfield SFb to the display panel 9. Further, as the selection signal S output from the display SF selection circuit 7 changes from S=0 to S=1 to S=2, the memory read control circuit 50 reads out the data for each subfield SFb from the field memory 4 in the following order. That is, when S=0 (in the case of the driving sequence A), the data is read out in the order of SFb3, SFb4, SFb5, SFb6, SFb7, SFb8, SFb9, and SFb10; when S=1 (in the case of the driving sequence B), the data is read out in the order of SFb3, SFb4, SFb5, SFb6, SFb7, SFb8, SFb9, and SFb2; and when S=2 (in the case of the driving sequence C), the data is read out in the order of SFb3, SFb4, SFb5, SFb6, SFb7, SFb8, SFb1, and SFb2.

In the plasma display apparatus, for example, the power consumption depends on the length of the sustain period within one field period, that is, the sum of the weights of the subfields; here, the sum of the weights in the driving sequence A for S=0 is 144, the sum of the weights in the driving sequence B for S=1 is 114, and the sum of the weights in the driving sequence C for S=2 is 87, which means that the driving sequence that does not use higher-order subfields SFb consumes less power.

As previously explained with reference to FIGS. 4 to 6, the SF conversion circuit 32 in the grayscaling circuit 3 holds three kinds of SF light emission data tables (SF light emission data tables A to C), and the data table to be used is selected based on the output S of the display SF selection circuit 7. That is, the table to be used is switched to the table A when S=0, to the table B when S=1, and to the table C when S=2.

In the table B, as previously explained with reference to FIG. 5, any input signal to the SF conversion circuit 32 that has a grayscale level higher than 116 is saturated at the level 116, and the maximum video portion to be saturated depends on the number of bits in the usage rate SFL output from the SF usage rate detection circuit 6; for example, in the case of 8 bits, the portion is 1/256 in terms of the display area ratio, and in the case of 9 bits, the ratio is 1/512, the area ratio thus being small enough not to cause any practical problem. By disregarding this small display area portion, the frequency of selecting S=1 dramatically increases. In a specific example, in an image showing a scene of a moonlit night, the brightness of the moon uses the subfield SFb10 of weight 32; here, if its area ratio is 1/256 or less, S=1 is selected.

As earlier described, the larger the number of bits in each output SFL of the usage rate detection circuit 6, the smaller the number of pixels disregarded, and the more accurately the decision can be made in selecting the correct driving sequence, but the decision becomes more sensitive to video signal noise, leading to an erroneous detection or resulting in frequent switching from one driving sequence to another; as a result, the frequency of selecting the driving sequence containing high-order subfields SFb increases, that is, the period during which the driving sequence that does not contain high-order subfields SFb is selected becomes shorter, and a situation can occur where the driving sequence that does not contain high-order subfields SFb is not selected even in the case of a scene containing a relatively dark image, thus defeating the purpose of increasing the number of output bits.

In the present embodiment, in switching from the driving sequence A for S=0 to the driving sequence B for S=1, since, of the outputs (subfields) SFb10 to SFb1 of the SF conversion circuit 32, those actually used in the driving sequence for display (driving) are the eight bits of the subfields SFb10 to SFb3 when S=0 and the eight bits of the subfields SFb9 to SFb2 when S=1, and since, at any gray scale level, the light emission pattern for the subfield SFb10 is the same between the light emission pattern table B and the light emission pattern table A, provisions are made to be able to detect the usage rate SFL10 of the SFb10 that is not actually used for driving in the driving sequence B for S=1.

In this way, according to the image display apparatus of the present embodiment, an image using the low-order bits can be effectively displayed by increasing the time during which the low-order bits are selected and driven for display. Furthermore, provisions are made to reduce the switching shock associated with the driving sequence switching so as not to give an unnatural feeling to the person (viewer) who is viewing the image display apparatus.

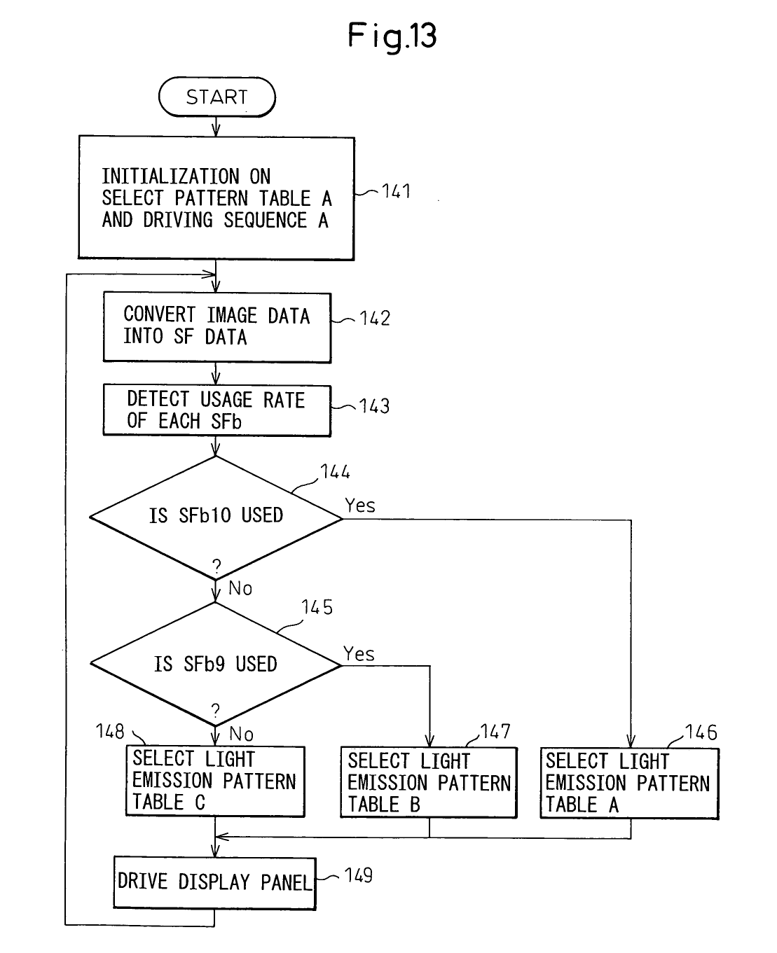

FIG. 13 is a flowchart showing one example of image display processing in the image display apparatus of the present invention.

First, when the image display processing is started, initialization of the image display apparatus is performed in step 141. At this time, the light emission pattern table A shown in FIG. 4 is selected as the light emission pattern table, and the driving sequence A shown at the bottom of FIG. 11 is selected as the driving sequence.

Next, the process proceeds to step 142 where the input image data is converted into subfield SFb data (SF conversion circuit 32), and in step 143, the usage rate of each subfield SFb is detected (SF usage rate detection circuit 6). Then, in step 144, it is determined whether the most heavily weighted subfield SFb10 is used or not, and in step 145, it is determined whether the second most heavily weighted subfield SFb9 is used or not. That is, in the processing of steps 144 and 145, if the subfield SFb10 is used, the process proceeds to step 146 to select the light emission pattern table A; if the subfield SFb10 is not used, but the subfield SFb9 is used, the process proceeds to step 147 to select the light emission pattern table B; and if neither the subfield SFb10 nor the subfield SFb9 is used, the process proceeds to step 148 to select the light emission pattern table C.

Then, the process proceeds to step 149 to drive the display panel 9 based on the selected light emission pattern table A, B, or C. The grayscale display capability can thus be enhanced.

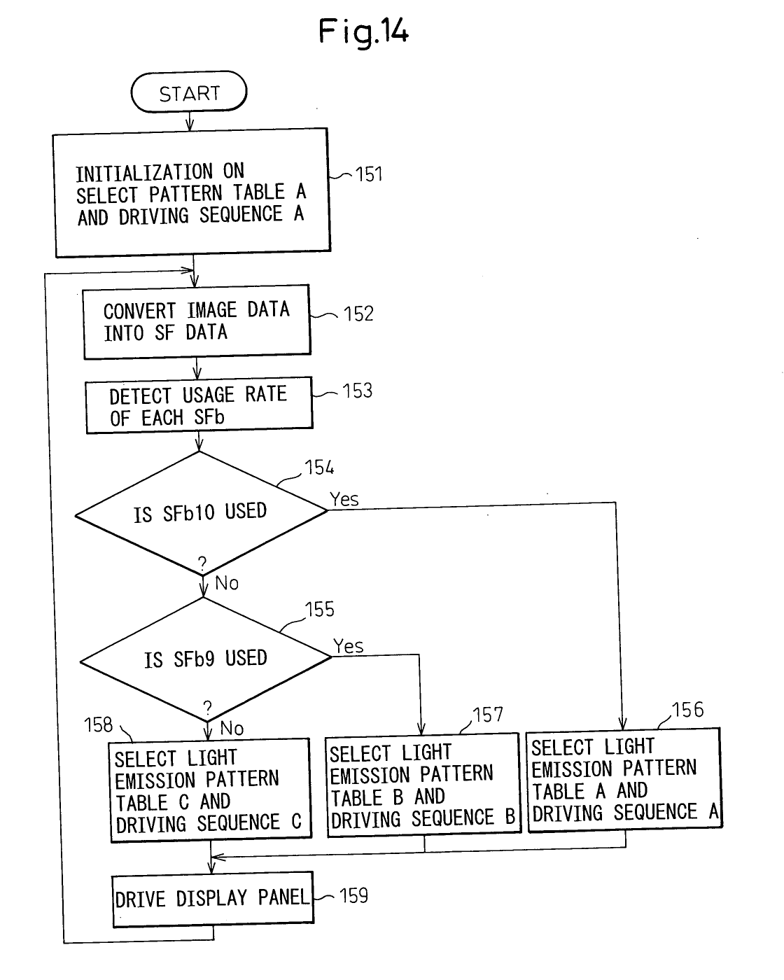

FIG. 14 is a flowchart showing another example of the image display processing in the image display apparatus of the present invention.

As is apparent from a comparison between FIG. 14 and the foregoing FIG. 13, steps 151 to 155 and 159 in the flowchart of FIG. 14 are the same as the corresponding steps 141 to 145 and 149 in the flowchart of FIG. 13. That is, the flowchart of FIG. 14 differs from the flowchart of FIG. 13 in the processing of steps 146 to 148.

That is, in the processing of steps 154 and 155, if the subfield SFb10 is used, the process proceeds to step 156 to select the light emission pattern table A and the driving sequence A; if the subfield SFb10 is not used, but the subfield SFb9 is used, the process proceeds to step 157 to select the light emission pattern table B and the driving sequence B; and if neither the subfield SFb10 nor the subfield SFb9 is used, the process proceeds to step 158 to select the light emission pattern table C and the driving sequence C.

Then, the process proceeds to step 159 to drive the display panel 9 based on the selected light emission pattern table A, B, or C and driving sequence A, B, or C. In this way, by switching both the light emission pattern table and the driving sequence, not only can the grayscale display capability be enhanced, but also the switching shock can be reduced.

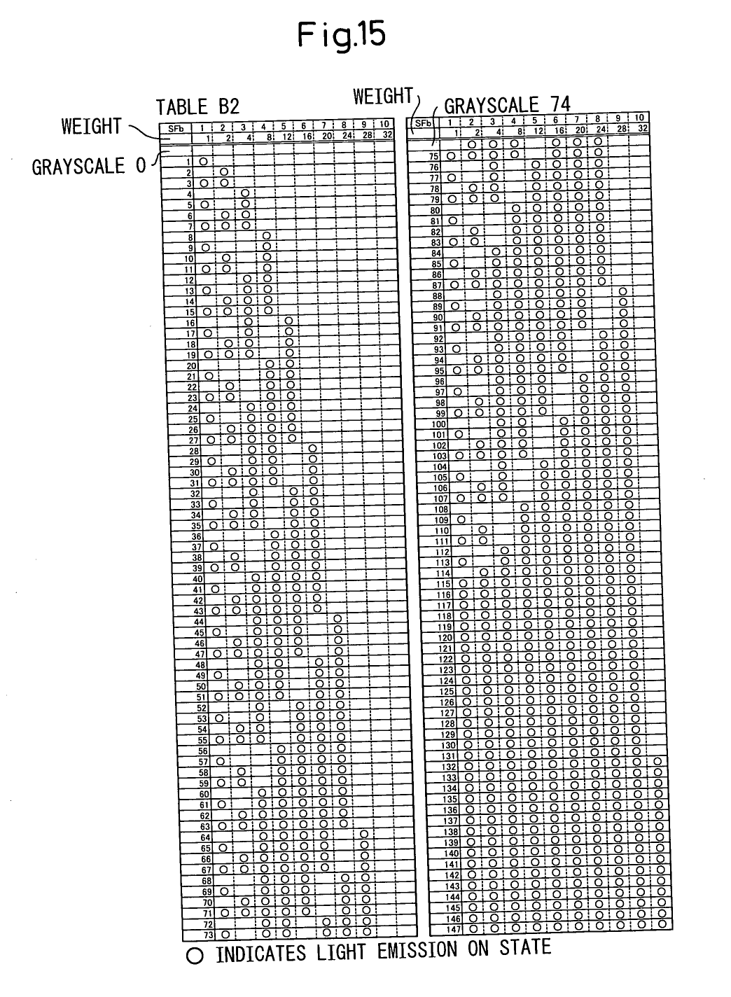

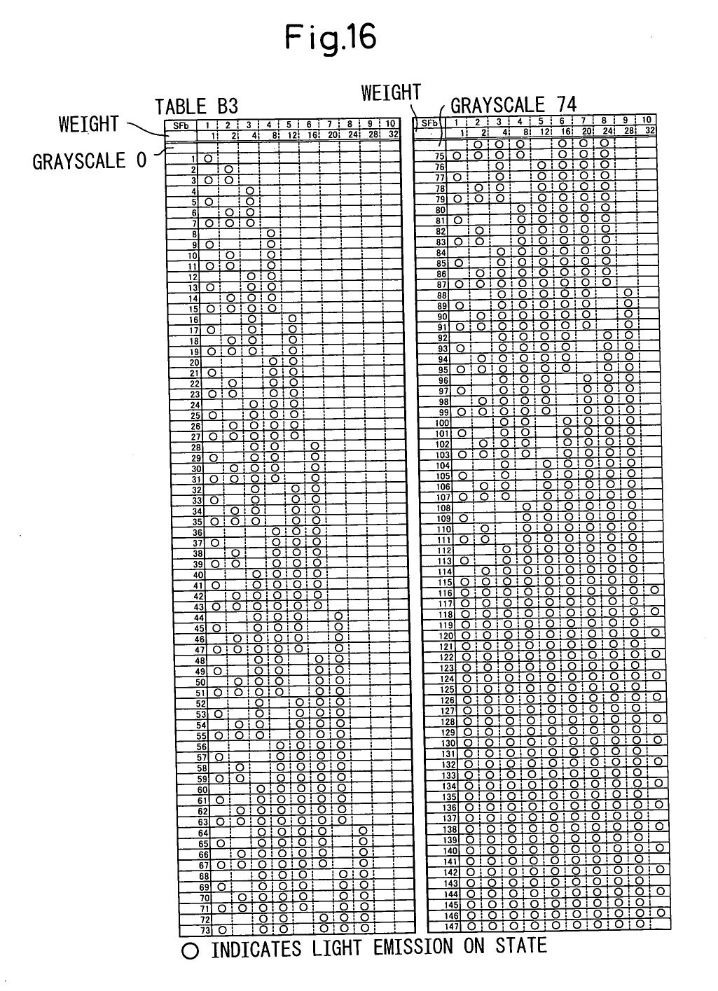

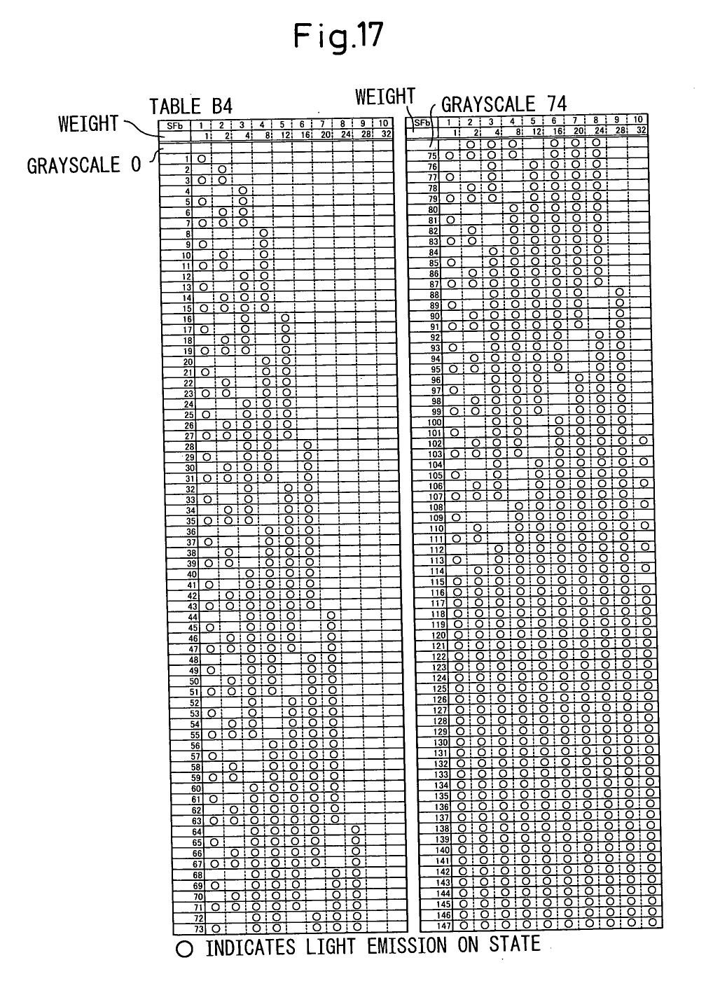

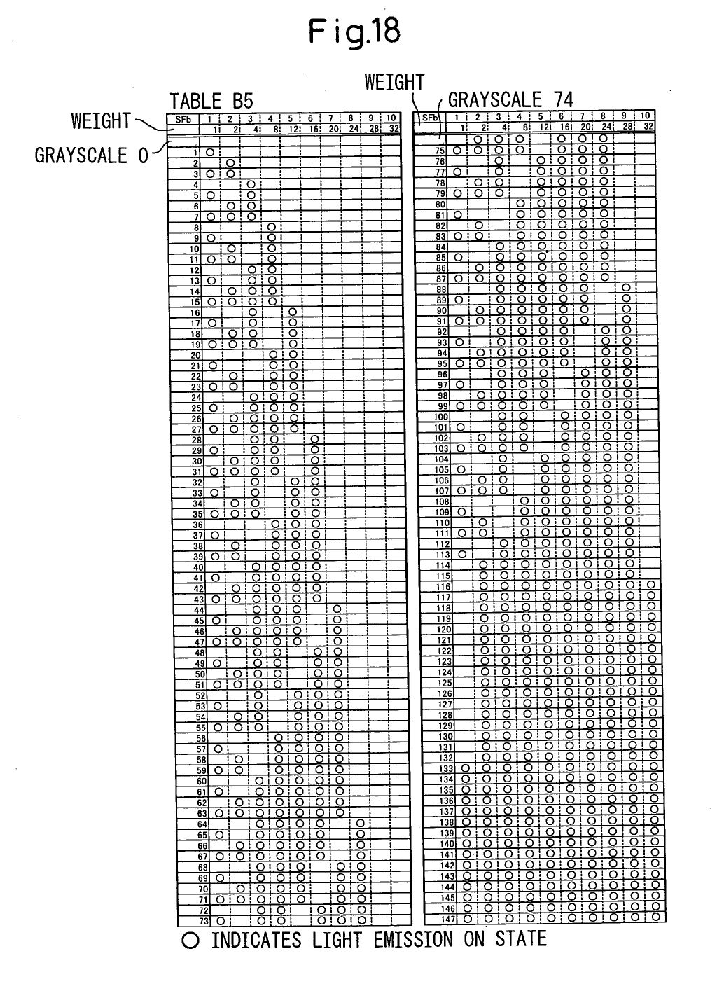

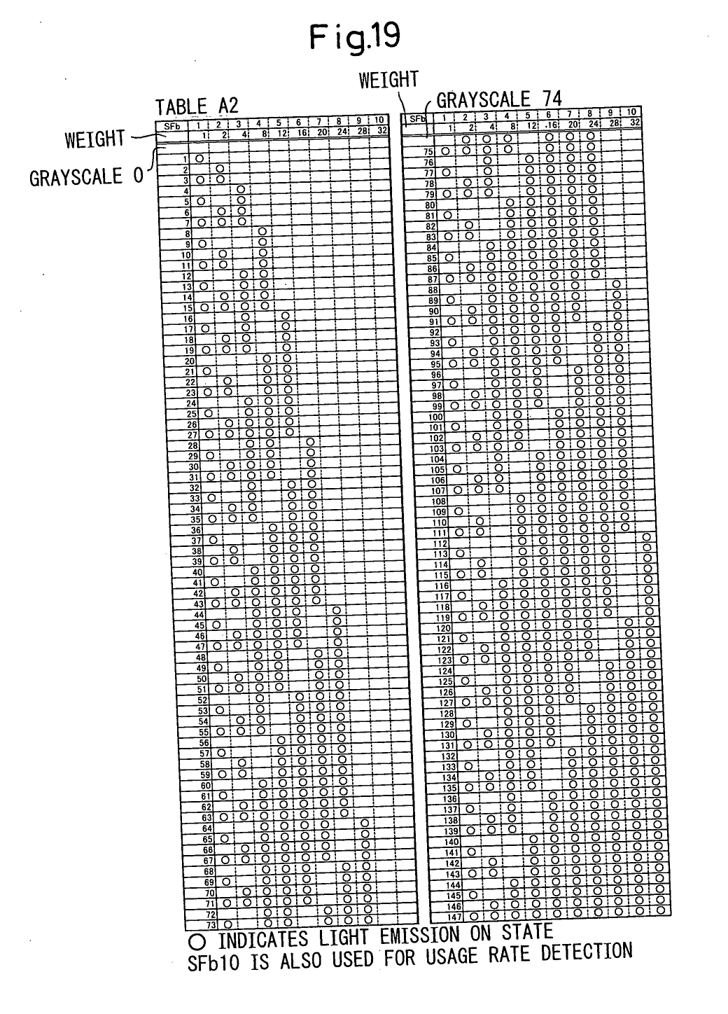

FIGS. 15 to 19 are diagrams each showing an example of the light emission pattern (light emission pattern table) in the SF conversion circuit in the image display apparatus of the present invention: FIG. 15 shows the fourth example of the light emission pattern (SF light emission pattern table B2), FIG. 16 shows the fifth example (SF light emission pattern table B3), FIG. 17 shows the sixth example of the light emission pattern (SF light emission pattern table B4), FIG. 18 shows the seventh example (SF light emission pattern table B5), and FIG. 19 shows the eighth example (SF light emission pattern table A2). In each figure, o indicates the light emission ON state.

First, as shown in FIG. 15, according to the pattern shown in the SF light emission pattern table B2, the subfield SFb10 is ON from the grayscale level 132 up to the highest grayscale level 147, compared with the light emission pattern table B previously shown in FIG. 5 in which the subfield SFb10 is ON from the grayscale level 116 to the grayscale level 147; that is, the grayscale level above which the subfield SFb10 is set ON is shifted toward the higher grayscale side, the subfield SFb10 being held OFF in the grayscale range from 116 to 131. Here, in the table B2, since the signal L10 becomes more difficult to detect than in the table B, the output S of the display SF selection circuit 7 can be provided with a hysteresis characteristic (causing a hysteresis to occur when switching from one selection signal S to another), which serves to alleviate the problem associated with the switching occurring too frequently within a short period of time.

Further, as shown in FIG. 16, according to the pattern data shown in the SF light emission pattern table B3, the subfield SFb10 is ON for every other grayscale level in the grayscale range from 116 to 147; in the table B3, as in the above table B2, since the signal L10 becomes more difficult to detect than in the table B, the output S of the display SF selection circuit 7 can be provided with a hysteresis characteristic, which serves to alleviate the problem associated with the switching occurring too frequently within a short period of time.

Further, as shown in FIG. 17, according to the pattern data shown in the SF light emission pattern table B4, as contrasted with the above table B3, the subfield SFb10 is ON for every other grayscale level in the grayscale range from 102 to 115. That is, the output S of the display SF selection circuit 7 is provided with a hysteresis characteristic by setting the subfield SFb10 ON for every other grayscale level in the grayscale range (from grayscale level 102 to grayscale level 115) in which the subfield SFb10 is OFF in the light emission pattern table A shown in FIG. 4.

On the other hand, as shown in FIG. 18, according to the SF light emission pattern table B5, the output S of the display SF selection circuit 7 is provided with a hysteresis characteristic by setting the subfield SFb1 OFF in the grayscale range from 114 to 132. In this way, the subfield ON/OFF state at a level near the maximum value, not at the maximum value, may be controlled to accomplish the purpose. Further, the number of subfields controlled to provide the output S with a hysteresis characteristic is not limited to one, but two or more subfields may be controlled.

Further, as shown in FIG. 19, while, in the SF light emission pattern table A, the carry grayscale level to the subfield SFb10 is the grayscale level 116, in the SF light emission pattern table A2 the carry grayscale level is the grayscale level 112, and in the grayscale range from 112 to 116, the sum of the weights of the ON subfields matches the grayscale level, the only difference from the SF light emission pattern table A being the light emission pattern data. When used in combination with the light emission pattern table B, since the grayscale level above which the subfield SFb10 is set ON is lower in the light emission pattern table A2 than in the light emission pattern table B, when S=0 the output S does not easily switch to S=1, and conversely, when S=1, the output S easily switches to S=0, thus achieving a hysteresis characteristic.

Here, the SF light emission data tables used in the SF conversion circuit 32 are not limited to the three kinds described above, the only requirement being that two or more kinds of data tables be provided. When the number of SF light emission data tables used in the SF conversion circuit 32 is increased, the number of grayscale levels can be increased for darker images by increasing the number of bits processed in the image display apparatus.

Further, by switching the output bits of the SF usage rate detection circuit 6, the signal S can be provided with a hysteresis characteristic. That is, in the case of the driving sequence A for S=0, for example, the 8 high-order bits including the MSB are set as the output bits of the SF usage rate detection circuit 6, and in the case of the driving sequence B for S=1, the 9 high-order bits including the MSB are set as the output bits of the SF usage rate detection circuit 6; then, the output 0 in the case of the 8 bits for S=0 becomes easier to detect, while the output 0 in the case of the 8 bits for S=1 becomes difficult to detect, thus introducing a hysteresis in switching between the signals S.

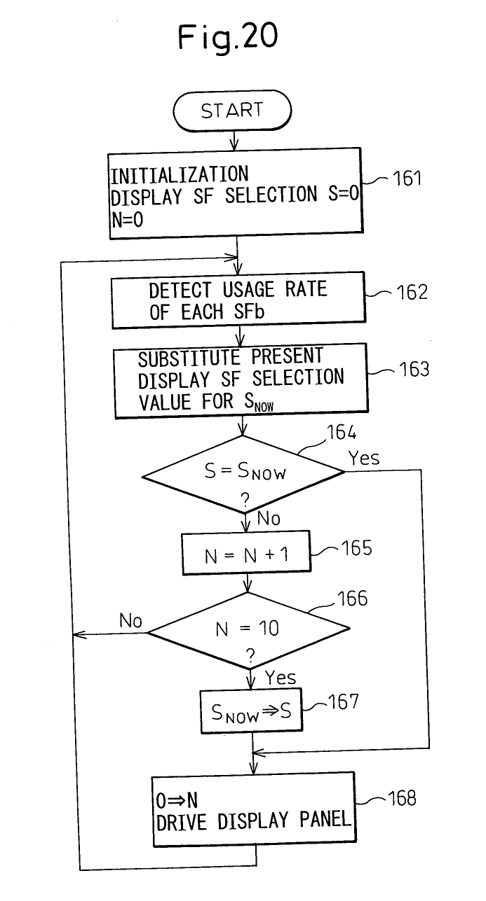

FIG. 20 is a flowchart showing one example of display SF selection processing in the image display apparatus of the present invention, illustrating the processing for providing the hysteresis characteristic to the output (selection signal S) of the display SF selection circuit 7.

First, when the display SF selection processing is started, initialization of the display SF selection circuit 7 is performed in step 161. That is, the display SF selection signal S is set as S=0, and a parameter N is set as N=0. Here, N is the parameter for achieving hysteresis.

Next, the process proceeds to step 162 to detect the usage rate of each subfield SFb. This processing corresponds to the processing performed in the SF usage rate detection circuit 6 described with reference to FIG. 8. The process further proceeds to step 163 where the display SF selection value generated by the current output of the selection number generating circuit 72 described with reference to FIG. 9 is substituted for S_{NOW}. Then, the process proceeds to step 164 where the current value of S_{NOW} is compared with the previous output S of the display SF selection circuit 7, and if S=S_{NOW} holds, the process proceeds to step 168, but if S=S_{NOW} does not hold, the process proceeds to step 165 where the parameter N is incremented by 1 (N=N+1).

In step 166, it is determined whether N equals 10 (N=10), and if SNOW has failed to match S ten times in succession, the process proceeds to step 167; otherwise, the process returns to step 162 to repeat the same processing until N reaches 10. If, in step 166, it is determined that SNOW has failed to match S ten times in succession (that is, N has reached 10), then in step 167 S_{NOW} is changed to S (S_{NOW} [symbol] S), and the process proceeds to step 168. In step 168, the parameter N is reset to 0 (0 [symbol] N), and the process returns to step 162 to repeat the same processing.

In the flowchart of FIG. 20, the number of times the comparison is made with the parameter N in step 166 is not limited to 10, but need only be set to a number larger than 1, to provide a hysteresis to the switching of the output signal S of the display SF selection circuit 7.

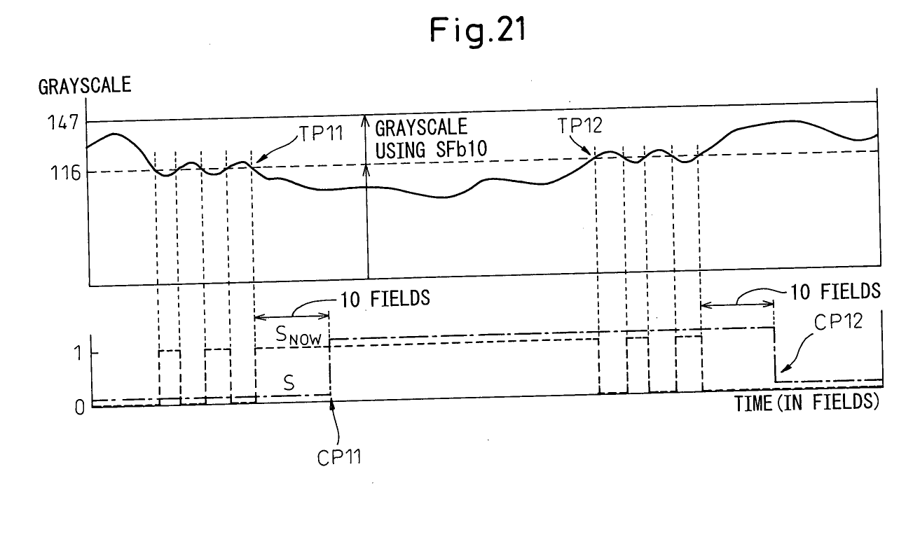

FIG. 21 is a diagram showing a first example of the hysteresis characteristic that the output of the display SF selection circuit exhibits in the image display apparatus of the present invention; the diagram here is for explaining the hysteresis characteristic that occurs in the switching of the output signal S of the display SF selection circuit 7 in accordance with the display SF selection processing described above with reference to the flowchart of FIG. 20.

As shown in FIG. 21, the output signal S of the display SF selection circuit 7 switches from S=0 to S=1 at timing CP11 which is 10 fields after the timing TP11 at which the peak value of the video signal drops below the grayscale level 116, the grayscale level below which the subfield SFb10 is not used, and switches from S=1 to S=0 at timing CP12 which is 10 fields after the timing TP12 at which the peak value of the video signal exceeds the grayscale level 116 at and above which the subfield SFb10 is used. In this way, according to the display SF selection processing shown in FIG. 20, by providing the hysteresis characteristic to the switching of the output signal S of the display SF selection circuit 7, the problem of the output frequently switching within a short period time can be alleviated.

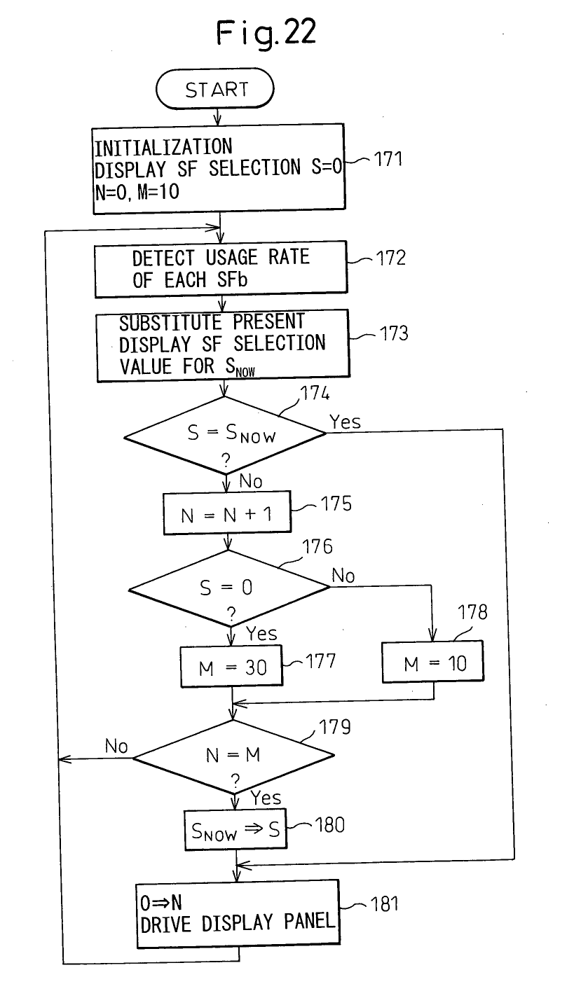

FIG. 22 is a flowchart showing another example of the display SF selection processing in the image display apparatus of the present invention.

As is apparent from a comparison between FIG. 22 and the foregoing FIG. 20, steps 172 to 175 and 180 and 181 in the flowchart of FIG. 22 are the same as the corresponding steps 162 to 165 and 167 and 169 in the flowchart of FIG. 20. That is, the flowchart of FIG. 22 differs from the flowchart of FIG. 20 in the processing of steps 161 and 166.

That is, when the display SF selection processing is started, initialization of the display SF selection circuit 7 is performed in step 171; here, the display SF selection signal S is set as S=0, and parameters N and M are set as N=0 and M=0, respectively. Here, N and M are the parameters for achieving hysteresis.

Then, after carrying out the steps 172 to 175 which correspond to the previously described steps 162 to 165 in FIG. 20, the process proceeds to step 176 where it is determined whether S=0 holds. If it is determined in step 176 that S=0 holds, the process proceeds to step 177 where M is set as M=30, after which the process proceeds to step 179; on the other hand, if it is determined that S=0 does not hold, the process proceeds to step 178 where M is set as M=10, after which the process proceeds to step 179.

In step 179, it is determined whether N=M holds, and if it is determined that N=M holds, the process proceeds to step 180, but if it is determined that N=M does not hold, the process returns to step 172 to repeat the same processing until N=M holds.

That is, the flowchart of FIG. 22 differs from the flowchart of FIG. 20 in that “10” in the decision “N=10?” in step 166 is replaced by the parameter M. If it is determined in step 174 that the values do not match, then if the current value of S is 0, 30 is substituted for M (step 177), but if the current value of S is 1, 10 is substituted for M (step 178).

Accordingly, if S is 0, and S_{NOW} is 1 thirty times in succession, S switches to 1, and if S is 1, and S_{NOW} is 0 ten times in succession, S switches to 0; in this way, the number of successive detections can be changed according to the current value of S, and the hysteresis characteristic can thus be adjusted. It will be appreciated here that the value “30” in step 177 and the value “10” in step 178 can be changed as needed.

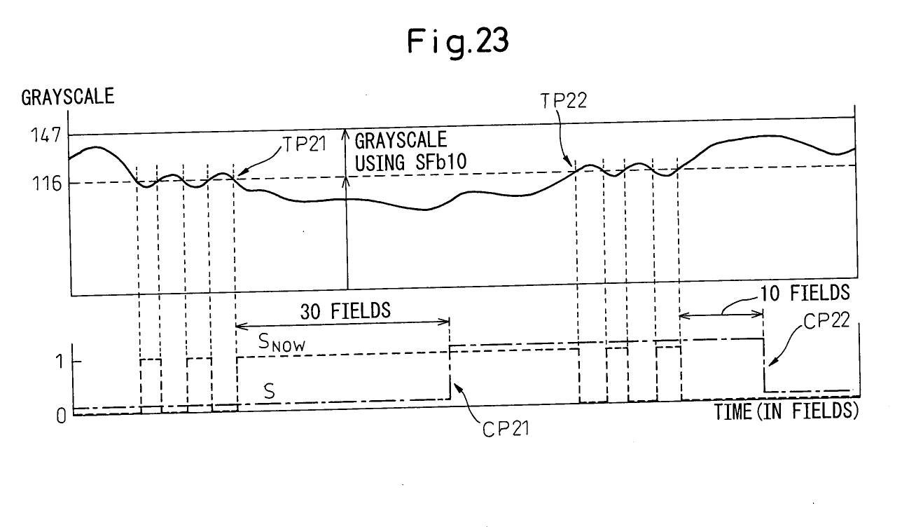

FIG. 23 is a diagram showing a second example of the hysteresis characteristic that the output of the display SF selection circuit exhibits in the image display apparatus of the present invention; the diagram here is for explaining the hysteresis characteristic that occurs in the switching of the output signal S of the display SF selection circuit 7 in accordance with the display SF selection processing described above with reference to the flowchart of FIG. 22.

As shown in FIG. 23, the output signal S of the display SF selection circuit 7 switches from S=0 to S=1 at timing CP21 which is 30 fields after the timing TP21 at which the peak value of the video signal drops below the grayscale level 116, the grayscale level below which the subfield SFb10 is not used, and switches from S=1 to S=0 at timing CP22 which is 10 fields after the timing TP22 at which the peak value of the video signal exceeds the grayscale level 116 at and above which the subfield SFb10 is used. In this way, according to the display SF selection processing shown in FIG. 22, by providing the hysteresis characteristic to the switching of the output signal S of the display SF selection circuit 7, the problem of the output frequently switching within a short period time can be alleviated. Here, according to the display SF selection processing shown in FIG. 22, since the value (30) substituted for M in step 177 is larger than the value (10) substituted for M in step 178, the switching from S=0 to S=1 is more difficult to occur than the switching from S=1 to S=0, and this serves to prevent the bright image portion in the subfield SFb10 from appearing washed out.

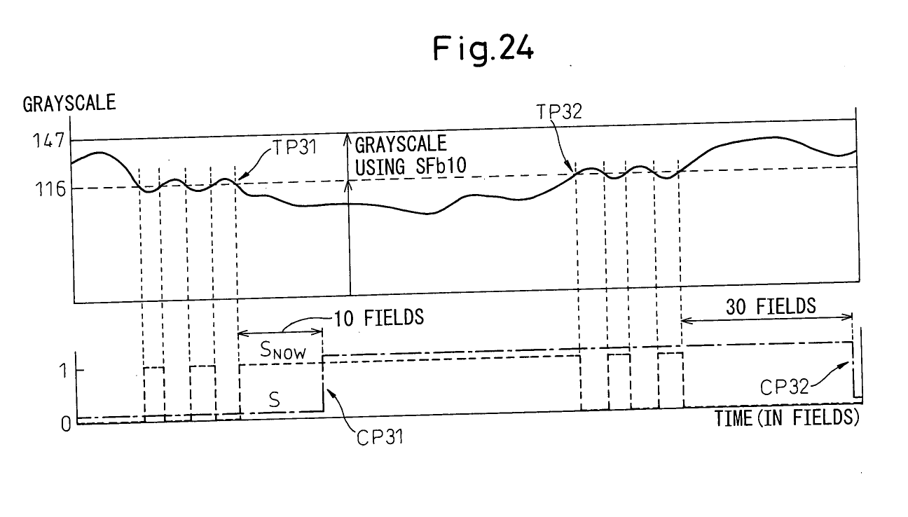

FIG. 24 is a diagram showing a third example of the hysteresis characteristic that the output of the display SF selection circuit exhibits in the image display apparatus of the present invention; the diagram here is for explaining the hysteresis characteristic that occurs in the switching of the output signal S of the display SF selection circuit 7 when the value to be substituted for M in step 177 is set to 10 (M=10) and the value to be substituted for M in step 178 is set to 30 (M=30) in the flowchart of FIG. 22.

As shown in FIG. 24, the output signal S of the display SF selection circuit 7 switches from S=0 to S=1 at timing CP31 which is 10 fields after the timing TP31 at which the peak value of the video signal drops below the grayscale level 116, the grayscale level below which the subfield SFb10 is not used, and switches from S=1 to S=0 at timing CP32 which is 30 fields after the timing TP32 at which the peak value of the video signal exceeds the grayscale level 116 at and above which the subfield SFb10 is used. In this case, since the switching from S=1 to S=0 becomes more difficult to occur than the switching from S=0 to S=1, favorable results can be obtained when giving priority to enhancing the display capability at low grayscale levels though the image may appear somewhat washed out.

In this way, the hysteresis characteristic that occurs in the switching of the output signal S of the display SF selection circuit 7 can be controlled by changing the values to be substituted for M in steps 177 and 178 in the flowchart of FIG. 22. Here, it is also possible to fine adjust the hysteresis characteristic, for example, by switching the output bits of the light emission pattern table B4 described with reference to FIG. 17 or the output bits of the previously described SF usage rate detection circuit 6.

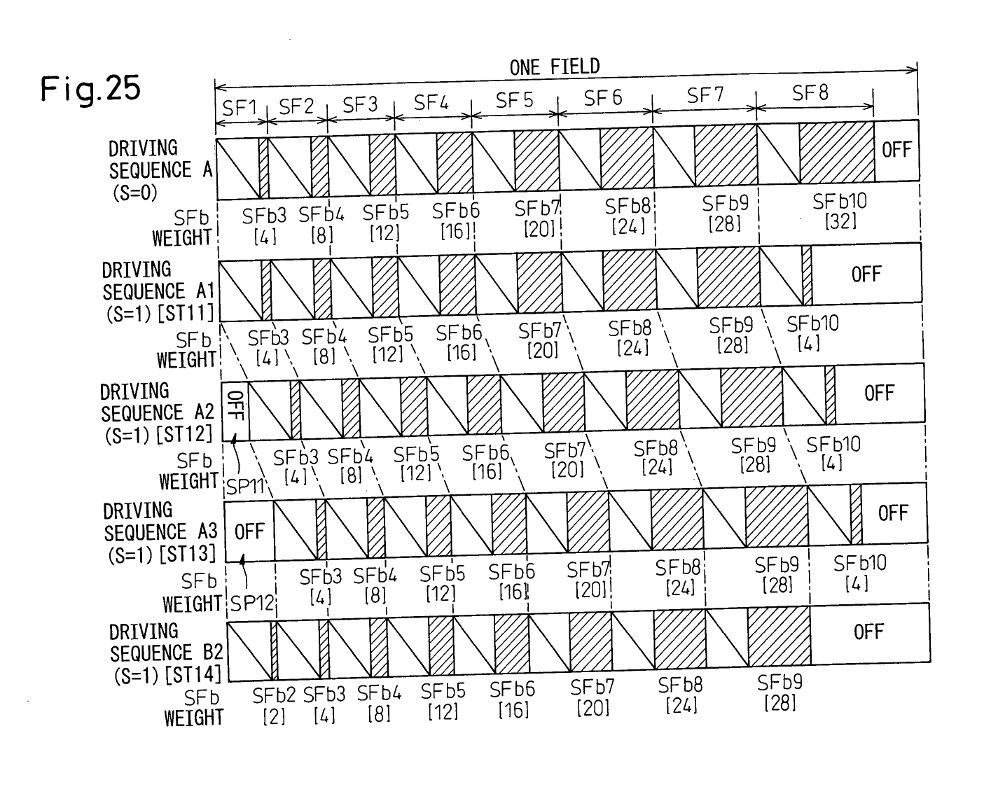

FIG. 25 is a diagram showing a second embodiment of the driving sequences used in the driving control circuit in the image display apparatus of the present invention; the diagram shown is for explaining the second embodiment which reduces the shock associated with the driving sequence switching in a different way than the first embodiment described with reference to FIG. 11.

As is apparent from a comparison between FIG. 25 and FIG. 11, the driving sequence B in the first embodiment of FIG. 11 and the driving sequence B2 in the second embodiment of FIG. 25 are both the driving sequence for S=1, but the difference is that while, in the driving sequence B of the first embodiment, the subfield SFb2 of weight 2 is driven at the end (SF8) of the sequence, in the driving sequence B2 of the second embodiment it is driven at the beginning (SF1) of the sequence.

In the foregoing first embodiment of FIG. 11, when the driving sequence A is switched in a single step to the driving sequence B, since the subfield SFb3 contains light emission due to the error diffusion of the subfield SFb2, the pixel turned on in the subfield SFb3 driven at the beginning of the sequence is turned on in the subfield SFb2 driven at the end of the driving sequence B; in this case, the amount of shift in the center of gravity is small as the weight of the subfield SFb3 is small, but if the usage rate of the subfield SFb3 is high, a slight shock is perceived though its magnitude is small. By contrast, in the second embodiment of FIG. 24, switching is made from S=0 to S=1 progressively in a plurality of steps.

In the first step ST11, the subfield SFb10 in SF8, which is little used for display in the driving sequence A for S=0, is set as a subfield having a sustain period of weight 4 to display the grayscale level 116 (driving sequence A1). That is, the length (number of pulses) of the sustain period in the subfield SFb10 is shortened from the length of weight 32 to the length of weight 4. Here, the sustain period in the subfield SFb10 may be set to 0, but in that case, the grayscale level 116 is not displayed.

Next, in the second step ST12, a quiescent period SP11 with a length not long enough to cause a shock is inserted before SF1 (driving sequence A2). In the third step ST13, the length of the period SP11 is gradually increased for each field in such a manner that the switching shock will not be perceived, until a quiescent period SP12 just long enough to drive the subfield SFb2 is obtained (driving sequence A3). Then, in the fourth step ST14, the subfield SFb10 is stopped, and the subfield SFb2 is inserted in SF1 (driving sequence B2). When switching from S=1 to S=0, the switching shock can be reduced in like manner by carrying out the above steps in the reverse order.

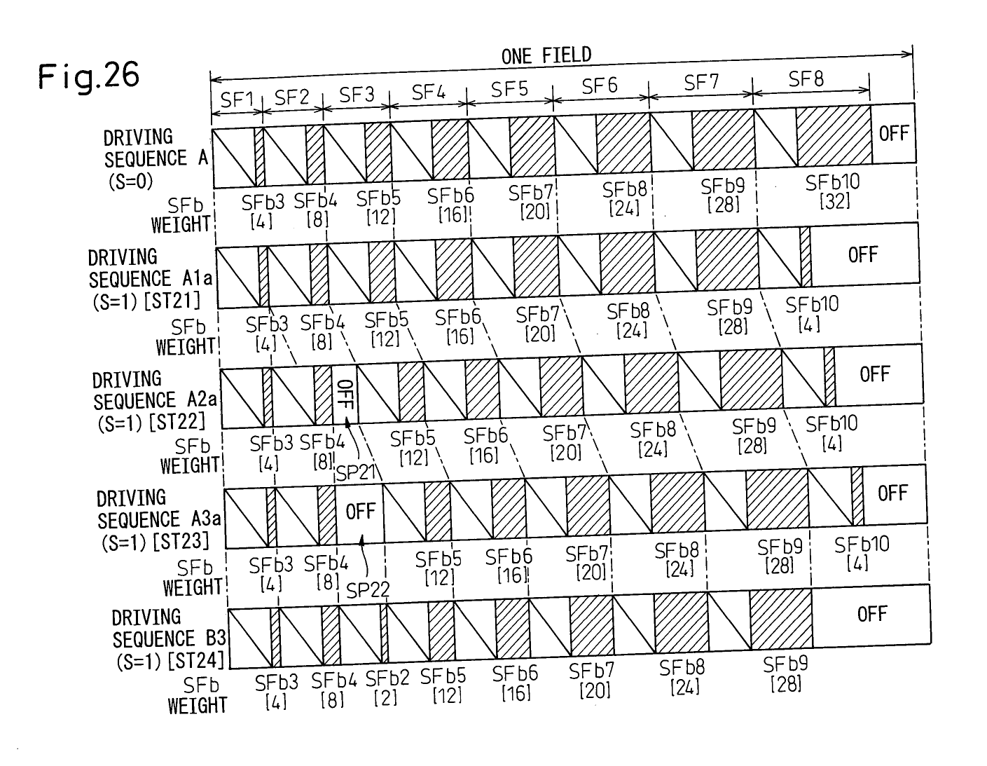

FIG. 26 is a diagram showing a third embodiment of the driving sequences used in the driving control circuit in the image display apparatus of the present invention.

In the second embodiment of the driving sequences described with reference to FIG. 25, the quiescent period SP11, SP12) is inserted at the beginning (SF1) of one field, but this quiescent period can be inserted in any suitable position; in the third embodiment, the usage rate of each subfield SFb is detected (the usage rates of the subfields SFb1 to SFb10 are detected using the adder circuits 601 to 610 and the usage rate calculating circuits 611 to 620 shown in FIG. 8), and provisions are made not to move a subfield having a high usage rate. More specifically, the third embodiment of FIG. 26 shows the case where the usage rate of the subfield SFb4 of weight 8 is high; in this case, in the second and third steps ST22 and ST23, the quiescent period SP21, SP22 is inserted in the position (SF3) following the subfield SFb4, and the subfield SFb2 of weight 2 is placed in that position.

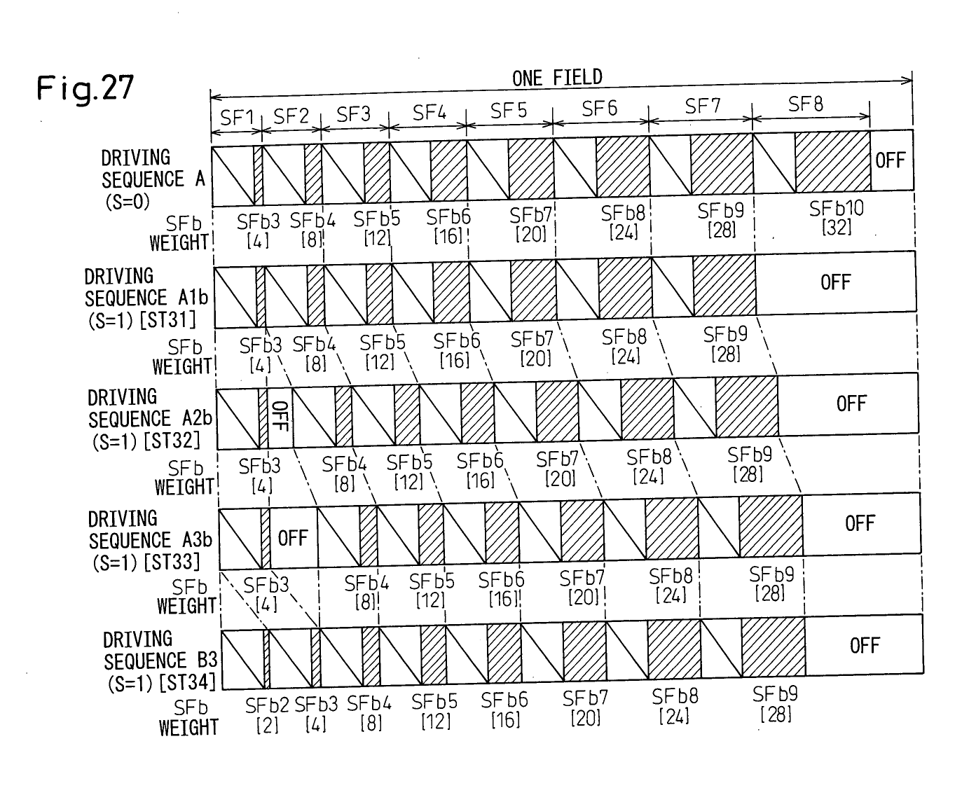

FIG. 27 is a diagram showing a fourth embodiment of the driving sequences used in the driving control circuit in the image display apparatus of the present invention.

In the driving sequences of the fourth embodiment shown in FIG. 27, SF8 is deleted in the first step ST31. Further, the subfields SFb2 to SFb9, including the subfield SFb2 of weight 2 inserted in the fourth step ST34, are reordered.

When switching the driving sequence, it is desirable that the center of gravity remain unchanged if at all possible, but subfields SFb whose weights are relatively not very large can be reordered because the center of gravity does not shift substantially if such subfields SFb are reordered. That is, since a moving image is moving at all times, the center of gravity of the image when switching from S=1 to S=0 is not always the same as the center of gravity of the image when switching from S=0 to S=1, and as a result, the center of gravity does not change substantially if subfields SFb whose weights are relatively small are reordered. There are, therefore, cases where it is preferable, from the standpoint of stable driving, to reorder the subfields rather than inserting a new subfield with a small weight into the quiescent period. In particular, it is preferable to drive the SFs in the order of increasing weight.

Here, it is desirable that the quiescent period to be inserted be inserted in an early time position in the one field, and that the subfields SFb be reordered in the order of increasing weight wherever possible.

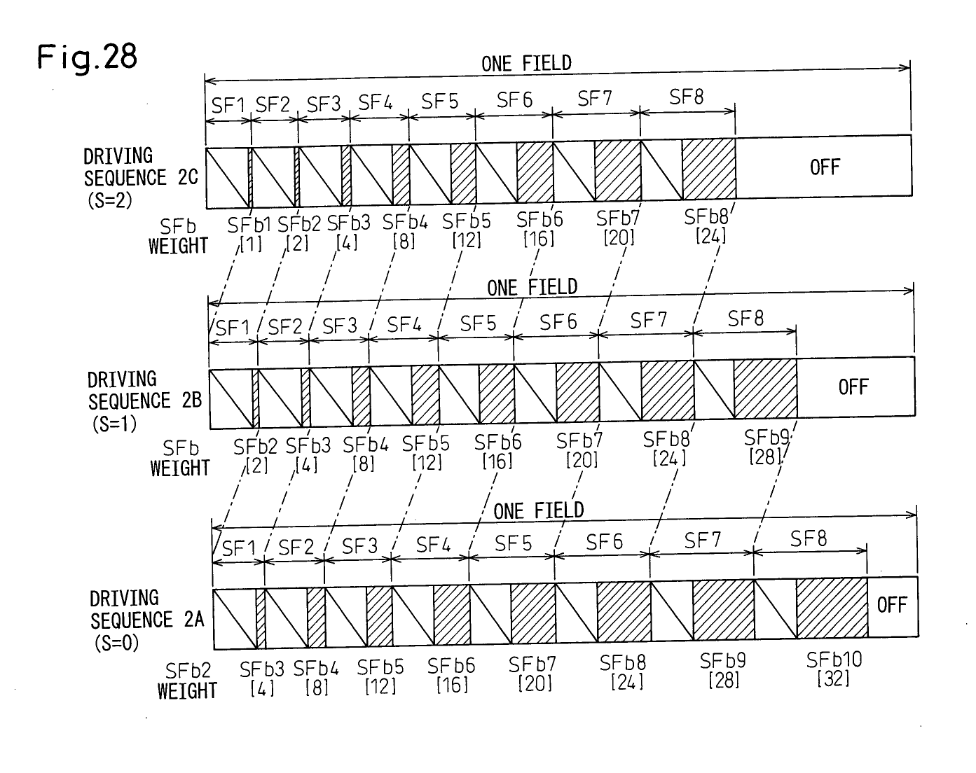

FIG. 28 is a diagram showing a fifth embodiment of the driving sequences used in the driving control circuit in the image display apparatus of the present invention.

When switching the driving sequence, the switching may be made as shown in the first embodiment of FIG. 11, but the switching can also be done as shown in the fifth embodiment of FIG. 28.

That is, if the driving sequence switching is performed as shown in the first embodiment when the usage rates of the relatively heavily weighted subfields (for example, SFb7 and SFb8) are high, and as shown in the fifth embodiment when the usage rates of the relatively lightly weighted subfields (for example, SFb3, SFb2, and SFb1) are high, the amount of shift in the center of gravity can be reduced; in this way, the mode of driving sequence switching can be changed according to the usage rate of each subfield SFb. Here, the usage rates of the subfields SFb1 to SFb10 are detected using the adder circuits 601 to 610 and the usage rate calculating circuits 611 to 620 shown in FIG. 8.

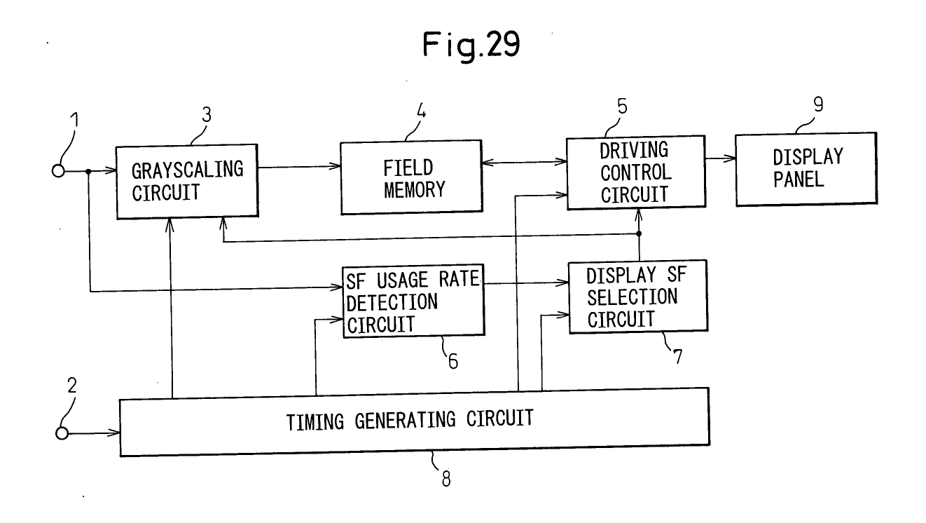

FIG. 29 is a block diagram showing another embodiment of an image display apparatus according to the present invention.

In FIG. 29, the video signal input terminal 1, synchronization signal input terminal 2, grayscaling circuit 3, field memory 4, control driving circuit 5, SF usage rate detection circuit 6, display SF selection circuit 7, timing generating circuit 8, and display panel 9 are the same as those described with reference to FIG. 2, and therefore, the description thereof will not be repeated here.

As is apparent from a comparison between FIG. 29 and FIG. 2, the usage rate detection circuit 6 in the image display apparatus of FIG. 2 receives at its input the output (SFb1 to SFb10) of the SF conversion circuit in the grayscaling circuit 3, whereas in the image display apparatus of the present embodiment shown in FIG. 29, the usage rate detection circuit 6 receives at its input the image input supplied via the video signal input terminal 1. That is, the image input supplied via the video signal input terminal 1, not the output of the grayscaling circuit 3, can be directly used as the input to the usage rate detection circuit 6.

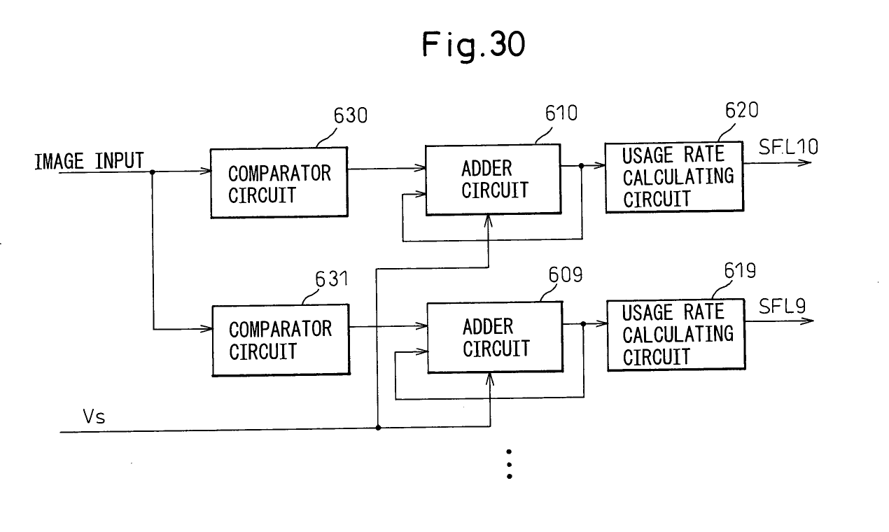

FIG. 30 is a block diagram showing another example of the SF usage rate detection circuit in the image display apparatus of the present invention; the circuit shown here can be applied as the SF usage rate detection circuit shown in FIG. 29.

The adder circuits 609 and 610 and the usage rate calculating circuits 619 and 620 in the SF usage rate detection circuit 6 previously shown in FIG. 8 correspond to the adder circuits 609 and 610 and the usage rate calculating circuits 619 and 620 in the SF usage rate detection circuit 6 of FIG. 29. Comparator circuits 630 and 631 each compare image input data with a predetermined value, and output “1” when the data is equal to or greater than the predetermined value and “0” when the data is less than the predetermined value. In this way, the number of pixels or the usage rate equal to or greater than the predetermined value can be detected, as with the SF usage rate detection circuit of FIG. 8. Here, the predetermined value is the numerical value obtained by converting into the image input the maximum grayscale value that can be represented by the subfields used in the light emission pattern table for display. That is, as many combinations of the comparator circuit, adder circuit, and usage rate calculating circuit as the number of light emission pattern tables used, minus one, are needed.

In the above description, it will be appreciated that the present invention can also be implemented for three RGB primary colors if the circuit is provided for each primary color signal. It will also be recognized that the application of the present invention is not limited to plasma display apparatuses.

In the present invention, the subfields may be weighted by data, as described above, or may be weighted by luminance.

As described in detail above, according to the present invention, the period during which the driving mode remains switched to the driving sequence designed to enhance the display capability at low grayscale levels can be lengthened. Further, according to the present invention, the shock associated with the driving sequence switching can be reduced. Furthermore, according to the present invention, the sustain light-emission period can be shortened, achieving a reduction in power consumption.

The present invention can be applied widely to image display apparatuses, including plasma display apparatuses; for example, the invention can be applied widely to image display apparatuses such as those used for personal computers, workstations, etc. or those used as hang-on-the-wall televisions or as apparatuses for displaying advertisements, information, etc.

Many different embodiments of the present invention may be constructed without departing from the scope of the present invention, and it should be understood that the present invention is not limited to the specific embodiments described in this specification, except as defined in the appended claims.

1. An image display apparatus displaying an image in multiple grayscales on a display panel by combining a plurality of weighted subfields into which one field has been divided, comprising:
an SF usage rate detection circuit detecting the number of pixels used within one field period for each weight of encoded subfield data;
a display SF selection circuit outputting a light emission pattern table selection signal, based on an output of said SF usage rate detection circuit;
an SF conversion circuit receiving an input image signal as well as said selection signal output from said display SF selection circuit, selecting one of a plurality of prestored light emission pattern tables in accordance with said selection signal, and outputting said encoded subfield data by encoding said input image signal in accordance with said selected light emission pattern table; and
a driving control circuit receiving the output of said SF conversion circuit, and driving said display panel in accordance with a prescribed driving sequence.

2. The image display apparatus as claimed in claim 1, wherein said SF usage rate detection circuit includes an adder circuit counting up the number of pixels for each of said subfields.

3. The image display apparatus as claimed in claim 2, wherein said SF usage rate detection circuit includes a usage rate calculating circuit calculating an usage rate of said subfield from an output of said adder circuit.

4. The image display apparatus as claimed in claim 1, wherein said SF usage rate detection circuit takes an image input as an input signal.

5. The image display apparatus as claimed in claim 4, wherein said SF usage rate detection circuit includes an comparator circuit comparing said input image with a predetermined value, and an adder circuit counting up the number of pixels each of which has been determined by said comparator circuit as being equal to or greater than said predetermined value.

6. The image display apparatus as claimed in claim 5, wherein as many combinations of said comparator circuit and said adder circuit are provided as the number of light emission tables minus one.

7. The image display apparatus as claimed in claim 6, wherein said predetermined value used for comparison in said comparator circuit is a value in the vicinity of a maximum grayscale that is represented by the subfields used for display in said light emission pattern table.

8. The image display apparatus as claimed in claim 1, wherein a plurality of said driving sequences are preset, and wherein said driving control circuit selects one driving sequence that matches said selected light emission pattern table, and drives said display panel in accordance with said selected driving sequence.

9. The image display apparatus as claimed in claim 1, wherein said SF usage rate detection circuit counts up the number of pixels over one field period for each weighted subfield data encoded into said subfield data, and outputs resulting data on a field-by-field basis.

10. The image display apparatus as claimed in claim 1, wherein said SF conversion circuit prestores data to select one of said plurality of light emission pattern tables in accordance with data provided in an arbitrary one of said light emission pattern tables.

11. The image display apparatus as claimed in claim 1, wherein pattern data indicating a light-emission ON/OFF state for each subfield in an arbitrary one of said light emission pattern tables is data for driving said display panel, and is also data based on which to switch between said light emission pattern tables.

12. The image display apparatus as claimed in claim 1, wherein:
said driving control circuit drives said display panel by using pattern data in an arbitrary one of said light emission pattern tables; and
said SF conversion circuit selects said light emission pattern table by using pattern data that is not used for driving said display panel in said arbitrary one of said light emission pattern tables.

13. The image display apparatus as claimed in claim 1, wherein pattern data used by said driving control circuit for driving said display panel comprises one or more kinds of pattern data including the least heavily weighted pattern data in said light emission table.

14. The image display apparatus as claimed in claim 1, wherein pattern data used for driving said display panel, from the highest grayscale X, or a grayscale close thereto, that is represented by the subfields used for display driving in said light emission pattern table to the highest grayscale Z that is represented by all the subfields in said light emission pattern table, is data where all pattern data or most of relatively heavily weighted pattern data indicate a light-emission ON state.

15. The image display apparatus as claimed in claim 14, wherein:
said plurality of light emission pattern tables comprise first and second light emission pattern tables where each corresponding one of said subfields is assigned the same weight; and
said first light emission pattern table provides an output which is linear with respect to an input and has a one-to-one correspondence therewith, while said second light emission pattern table is the light emission pattern table described in claim 14.

16. The image display apparatus as claimed in claim 15, wherein the grayscale from said grayscale X to said grayscale Z of the data that is said second light emission pattern table to switch between said emission pattern tables and that indicates the light-emission ON state of one or a plurality of pieces of weighted pattern data, is the same as the grayscale from said grayscale X to said grayscale Z of the data that is said first light emission pattern table, and that indicates the light-emission ON state of one or a plurality of pieces of pattern data of the same weight of said second light emission pattern table to switch between said light emission pattern tables.

17. The image display apparatus as claimed in claim 15, wherein the data that is used to switch between said light emission pattern tables, and that indicates the light-emission ON state of one or a plurality of pieces of weighted pattern data, is located at a grayscale lower than said grayscale X in said second light emission pattern table.

18. The image display apparatus as claimed in claim 15, wherein the number of pieces of data each of which is used in said second light emission pattern table to switch between said light emission pattern tables from said grayscale X to said grayscale Z, and which indicates the light emission ON state for each of one or a plurality of pieces of weighted pattern data, is smaller than the number of pieces of data which indicate the light emission ON state from said grayscale X to said grayscale Z in said first light emission pattern table.

19. The image display apparatus as claimed in claim 8, wherein said plurality of driving sequences include subfields of the same weight and subfields of different weights, and time positions at which the subfields of the same weight are caused to emit light are substantially the same between said plurality of driving sequences.

20. The image display apparatus as claimed in claim 8, wherein said plurality of driving sequences include subfields of the same weight and subfields of different weights, and the order where each of the subfields of the same weight is caused to emit light is the same between said plurality of driving sequences.

21. The image display apparatus as claimed in claim 1, wherein said display SF selection circuit switches the output of said display SF selection circuit when the output of said SF usage rate detection circuit for each weighted subfield is detected as being equal to or lower than a predetermined value.

22. The image display apparatus as claimed in claim 1, wherein said display SF selection circuit switches the output of said display SF selection circuit when the output of said SF usage rate detection circuit for one or a plurality of weighted subfields is detected as being zero.

23. The image display apparatus as claimed in claim 1, wherein said display SF selection circuit switches an output bit count of said SF usage rate detection circuit in accordance with the output of said display SF selection.

24. The image display apparatus as claimed in claim 1, wherein said display SF selection circuit switches the output on a field-by-field basis, and determines the present output value based on an output result of a previous field.

25. The image display apparatus as claimed in claim 24, wherein the output of said display SF selection circuit has a hysteresis characteristic.

26. The image display apparatus as claimed in claim 1, further comprising an error diffusion control circuit, provided between an image input and said SF conversion circuit, for switching an output bit count of an error diffusion circuit in accordance with the output of said display SF selection circuit.

27. The image display apparatus as claimed in claim 8, wherein said driving control circuit switches from one driving sequence to another progressively in one or a plurality of steps.

28. The image display apparatus as claimed in claim 27, wherein said one or said plurality of steps where said driving control circuit switches from one driving sequence to another involve making a sustain period in a relatively heavily weighted and unused subfield equal to or shorter than a sustain period in the least heavily weighted subfield used for display driving, or equal to zero.

29. The image display apparatus as claimed in claim 27, wherein said one or said plurality of steps where said driving control circuit switches from one driving sequence to another involve stopping a relatively heavily weighted subfield having a usage rate of zero.

30. The image display apparatus as claimed in claim 27, wherein said one or said plurality of steps where said driving control circuit switches from one driving sequence to another involve inserting a quiescent period before the first subfield or between arbitrarily selected subfields.

31. The image display apparatus as claimed in claim 27, wherein said one or said plurality of steps where said driving control circuit switches from one driving sequence to another involve lengthening a quiescent period gradually in steps, until said quiescent period becomes substantially equal in duration to the period of the least heavily weighted subfield currently driven.

32. The image display apparatus as claimed in claim 27, wherein said one or said plurality of steps where said driving control circuit switches from one driving sequence to another involve lengthening a quiescent period gradually in steps, until said quiescent period becomes substantially equal in duration to the period of a subfield whose weight is smaller by one than the least heavily weighted subfield currently driven.

33. The image display apparatus as claimed in claim 27, wherein said one or said plurality of steps where said driving control circuit switches from one driving sequence to another involve, in a final step thereof, inserting in a quiescent period a subfield whose weight is smaller by one than the least heavily weighted subfield currently displayed.

34. The image display apparatus as claimed in claim 27, wherein said one or said plurality of steps where said driving control circuit switches from one driving sequence to another involve, in a final step thereof, inserting in a quiescent period a subfield whose weight is smaller by one than the least heavily weighted subfield currently displayed, and stopping a subfield to which the most heavily weighted subfield data is assigned.

35. The image display apparatus as claimed in claim 27, wherein said one or said plurality of steps where said driving control circuit switches from one driving sequence to another involve, in a final step thereof, inserting in a quiescent period a subfield whose weight is smaller by one than the least heavily weighted subfield currently displayed, and rearranging the time order in which to drive said plurality of subfields.

36. The image display apparatus as claimed in claim 27, wherein said one or said plurality of steps where said driving control circuit switches from one driving sequence to another involve, in a final step thereof, inserting in a quiescent period a subfield whose weight is smaller by one than the least heavily weighted subfield currently displayed, and rearranging the time order in which to drive said plurality of subfields, in order of increasing weight.

37. The image display apparatus as claimed in claim 8, wherein said driving control circuit drives said display panel by selecting one driving sequence from among said plurality of driving sequences for said selected one light emission pattern table.

38. The image display apparatus as claimed in claim 1, wherein in said plurality of light emission pattern tables, the weight of a relatively lightly weighted subfield is a value expressed as a power of 2, while the weight of a relatively heavily weighted subfield is not a value expressed as a power of 2.

39. The image display apparatus as claimed in claim 1, wherein said image display apparatus is a plasma display apparatus.

40. An image display apparatus displaying an image in multiple grayscales in accordance with a signal level of an input signal, wherein the image is displayed by switching, according to video content thereof, between a first grayscale characteristic where an output level monotonically increases with increasing grayscale and a second grayscale characteristic including a region where the output level remains constant despite the increase in grayscale.

41. The image display apparatus as claimed in claim 40, wherein said second grayscale characteristic has a finer grayscale step in a low grayscale region than said first grayscale characteristic.

42. The image display apparatus as claimed in claim 40, wherein said image display apparatus is a plasma display apparatus.

43. A driving method for an image display apparatus displaying an image in multiple grayscales on a display panel by combining a plurality of weighted subfields into which one field has been divided, comprising:
detecting the number of pixels used within one field period for each encoded subfield;
outputting a light emission pattern table selection signal in accordance with the number of pixels detected for each subfield;
receiving an input image signal, selecting one of a plurality of prestored light emission pattern tables in accordance with said selection signal, and outputting said encoded subfield data by encoding said input image signal in accordance with said selected light emission pattern table; and
displaying an image in accordance with said encoded subfield data by using a prescribed driving sequence.

44. The driving method for an image display apparatus as claimed in claim 43, wherein the outputting of the light emission pattern table selection signal detects an usage rate of each subfield based on the number of pixels detected for said each subfield, and outputs said light emission pattern table selection signal in accordance with said detected subfield usage rate.

45. The driving method for an image display apparatus as claimed in claim 43, wherein the detecting of the number of pixels takes an image input as an input signal.

46. The driving method for an image display apparatus as claimed in claim 45, wherein the detecting of the number of pixels compares said input image with a predetermined value, and counts up the number of pixels each of which has been determined as a result of said comparison as being equal to or greater than said predetermined value.

47. The driving method for an image display apparatus as claimed in claim 46, wherein said predetermined value is a value in the vicinity of a maximum grayscale that is represented by the subfields used for display in said light emission pattern table.

48. The driving method for an image display apparatus as claimed in claim 43, wherein a plurality of said driving sequences are preset, and wherein the displaying of the image selects one driving sequence that matches said selected light emission pattern table, and displays an image in accordance with said selected driving sequence.

49. The driving method for an image display apparatus as claimed in claim 43, wherein the detecting of the number of pixels counts up the number of pixels over one field period for each weighted subfield data encoded into said subfield data, and outputs resulting data on a field-by-field basis.

50. The driving method for an image display apparatus as claimed in claim 43, wherein the outputting encoded subfield data prestore data selecting one of said plurality of light emission pattern tables in accordance with data provided in an arbitrary one of said light emission pattern tables.

51. The driving method for an image display apparatus as claimed in claim 43, wherein in the outputting encoded subfield data, pattern data indicating a light-emission ON/OFF state for each subfield in an arbitrary one of said light emission pattern tables is data for driving said display panel, and is also data based on which to switch between said light emission pattern tables.

52. The driving method for an image display apparatus as claimed in claim 43, wherein:
the displaying of the image drives said display panel by using pattern data in an arbitrary one of said light emission pattern tables; and
the outputting encoded subfield data prestore data selecting said light emission pattern table by using pattern data that is not used for driving said display panel in said arbitrary one of said light emission pattern tables.

53. The driving method for an image display apparatus as claimed in claim 43, wherein the displaying of the image drives said display panel by using one or more kinds of pattern data including the least heavily weighted pattern data in said light emission table.

54. The driving method for an image display apparatus as claimed in claim 43, wherein pattern data used for driving said display panel, from the highest grayscale X, or a grayscale close thereto, that is represented by the subfields used for display driving in said light emission pattern table to the highest grayscale Z that is represented by all the subfields in said light emission pattern table, is data where all pattern data or most of relatively heavily weighted pattern data indicates a light-emission ON state.

55. The driving method for an image display apparatus as claimed in claim 54, wherein:
said plurality of light emission pattern tables comprise first and second light emission pattern tables where each corresponding one of said subfields is assigned the same weight; and
said first light emission pattern table provides an output which is linear with respect to an input and has a one-to-one correspondence therewith, while said second light emission pattern table is the light emission pattern table described in claim 54.

56. The driving method for an image display apparatus as claimed in claim 55, wherein the grayscale from said grayscale X to said grayscale Z of the data that is said second light emission pattern table to switch between said emission pattern tables and that indicates the light-emission ON state of one or a plurality of pieces of weighted pattern data, is the same as the grayscale from said grayscale X to said grayscale Z of the data that is said first light emission pattern table, and that indicates the light-emission ON state of one or a plurality of pieces of pattern data of the same weight of said second light emission pattern table to switch between said light emission pattern tables.

57. The driving method for an image display apparatus as claimed in claim 55, wherein the data that is used to switch between said light emission pattern tables, and that indicates the light-emission ON state of one or a plurality of pieces of weighted pattern data, is located at a grayscale lower than said grayscale X in said second light emission pattern table.

58. The driving method for an image display apparatus as claimed in claim 55, wherein the number of pieces of data each of which is used in said second light emission pattern table to switch between said light emission pattern tables from said grayscale X to said grayscale Z, and which indicates the light emission ON state for each of one or a plurality of pieces of weighted pattern data, is smaller than the number of pieces of data which indicate the light emission ON state from said grayscale X to said grayscale Z in said first light emission pattern table.

59. The driving method for an image display apparatus as claimed in claim 48, wherein said plurality of driving sequences include subfields of the same weight and subfields of different weights, and time positions at which the subfields of the same weight are caused to emit light are substantially the same between said plurality of driving sequences.

60. The driving method for an image display apparatus as claimed in claim 48, wherein said plurality of driving sequences include subfields of the same weight and subfields of different weights, and the order where each of the subfields of the same weight is caused to emit light is the same between said plurality of driving sequences.

61. The driving method for an image display apparatus as claimed in claim 43, wherein the outputting of the light emission pattern table selection signal switches said selection signal when the output for each weighted subfield in the detecting of the number of pixels is detected as being equal to or lower than a predetermined value.

62. The driving method for an image display apparatus as claimed in claim 43, wherein the outputting of the light emission pattern table selection signal switches said selection signal when the output for one or a plurality of weighted subfields in the detecting of the number of pixels is detected as being zero.

63. The driving method for an image display apparatus as claimed in claim 43, wherein the outputting of the light emission pattern table selection signal switches an output bit count for said detected number of pixels in accordance with said selection signal.

64. The driving method for an image display apparatus as claimed in claim 43, wherein the outputting of the light emission pattern table selection signal switches the output on a field-by-field basis, and determines the present output value based on an output result of a previous field.

65. The driving method for an image display apparatus as claimed in claim 64, wherein the outputting of the light emission pattern table selection signal outputs said selection signal by providing a hysteresis characteristic thereto.

66. The driving method for an image display apparatus as claimed in claim 43, further comprising changing the number of bits used for error diffusion in accordance with said selection signal.

67. The driving method for an image display apparatus as claimed in claim 48, wherein switching from one driving sequence to another is done progressively in one or a plurality of steps.

68. The driving method for an image display apparatus as claimed in claim 67, wherein said one or said plurality of steps where switching is made from one driving sequence to another involve making a sustain period in a relatively heavily weighted and unused subfield equal to or shorter than a sustain period in the least heavily weighted subfield used for display driving, or equal to zero.

69. The driving method for an image display apparatus as claimed in claim 67, wherein said one or said plurality of steps where switching is made from one driving sequence to another involve stopping a relatively heavily weighted subfield having a usage rate of zero.

70. The driving method for an image display apparatus as claimed in claim 67, wherein said one or said plurality of steps where switching is made from one driving sequence to another involve inserting a quiescent period before the first subfield or between arbitrarily selected subfields.

71. The driving method for an image display apparatus as claimed in claim 67, wherein said one or said plurality of steps where switching is made from one driving sequence to another involve lengthening a quiescent period gradually in steps, until said quiescent period becomes substantially equal in duration to the period of the least heavily weighted subfield currently driven.

72. The driving method for an image display apparatus as claimed in claim 67, wherein said one or said plurality of steps where switching is made from one driving sequence to another involve lengthening a quiescent period gradually in steps, until said quiescent period becomes substantially equal in duration to the period of a subfield whose weight is smaller by one than the least heavily weighted subfield currently driven.

73. The driving method for an image display apparatus as claimed in claim 67, wherein said one or said plurality of steps where switching is made from one driving sequence to another involve, in a final step thereof, inserting in a quiescent period a subfield whose weight is smaller by one than the least heavily weighted subfield currently displayed.

74. The driving method for an image display apparatus as claimed in claim 67, wherein said one or said plurality of steps where switching is made from one driving sequence to another involve, in a final step thereof, inserting in a quiescent period a subfield whose weight is smaller by one than the least heavily weighted subfield currently displayed, and stopping a subfield to which the most heavily weighted subfield data is assigned.

75. The driving method for an image display apparatus as claimed in claim 67, wherein said one or said plurality of steps where switching is made from one driving sequence to another involve, in a final step thereof, inserting in a quiescent period a subfield whose weight is smaller by one than the least heavily weighted subfield currently displayed, and rearranging the time order in which to drive said plurality of subfields.

76. The driving method for an image display apparatus as claimed in claim 67, wherein said one or said plurality of steps where switching is made from one driving sequence to another involve, in a final step thereof, inserting in a quiescent period a subfield whose weight is smaller by one than the least heavily weighted subfield currently displayed, and rearranging the time order in which to drive said plurality of subfields, in order of increasing weight.

77. The driving method for an image display apparatus as claimed in claim 48, wherein said display panel is driven by selecting one driving sequence from among said plurality of driving sequences for said selected one light emission pattern table.

78. The driving method for an image display apparatus as claimed in claim 43, wherein in said plurality of light emission pattern tables, the weight of a relatively lightly weighted subfield is a value expressed as a power of 2, while the weight of a relatively heavily weighted subfield is not a value expressed as a power of 2.

79. The driving method for an image display apparatus as claimed in claim 43, wherein said image display apparatus is a plasma display apparatus.

80. A driving method for an image display apparatus displaying an image in multiple grayscales in accordance with a signal level of an input signal, wherein the image is displayed by switching, according to video content thereof, between a first grayscale characteristic where an output level monotonically increases with increasing grayscale and a second grayscale characteristic which includes a region where the output level remains constant despite the increase in grayscale.

81. The driving method for an image display apparatus as claimed in claim 80, wherein said second grayscale characteristic has a finer grayscale step in a low grayscale region than said first grayscale characteristic.

82. The driving method for an image display apparatus as claimed in claim 80, wherein said image display apparatus is a plasma display apparatus.
